(19) United States
(12) Patent Application Publication
(10) Pub. No.: US 2024/0320069 A1
(43) Pub. Date: Sep. 26, 2024

(54) GRAPH QUERY LANGUAGE API FOR DATA QUERY AND MANIPULATION SERVICES IN SIXTH GENERATION SERVICE-BASED ARCHITECTURES

(71) Applicant: Intel Corporation, Santa Clara, CA (US)

(72) Inventors: Xiaopeng TONG, Beijing (CN); Qian LI, Portland, OR (US); Zongrui DING, Portland, OR (US); Alexandre Saso STOJANOVSKI, Paris (FR); Thomas LUETZENKIRCHEN; Abhijeet KOLEKAR, Portland, OR (US); Youn Hyoung HEO, Seoul (KR); Sangeetha L. BANGOLAE, Portland, OR (US); RongZhen YANG, Shanghai (CN)

(73) Assignee: Intel Corporation, Santa Clara, CA (US)

(21) Appl. No.: 18/397,772

(22) Filed: Dec. 27, 2023

(30) Foreign Application Priority Data
Mar. 24, 2023 (WO) PCT/CN2023/083675

(51) Int. Cl. G06F 9/54; G06F 16/242; G06F 16/953; H04L 67/60

(52) U.S. Cl. CPC G06F 9/547; G06F 16/2433; G06F 16/953; H04L 67/60

(57) ABSTRACT

This disclosure describes systems, methods, and devices for providing data query and manipulation services. A wireless communications network service-based architecture for providing data query and manipulation services may detect a request from a service consumer, received at a GraphQL interface of a network function, to query or manipulate data; and provide, using the GraphQL interface, a response to the request.

### CROSS-REFERENCE TO RELATED PATENT APPLICATION(S)

This application claims the benefit of PCT Provisional Application No. PCT/CN2023/083675, filed Mar. 24, 2023, the disclosure of which is incorporated herein by reference as if set forth in full.

### TECHNICAL FIELD

This disclosure generally relates to systems and methods for wireless communications and, more particularly, to enabling a query language application programming interface for data query and modification services for 6G service-based architecture.

### BACKGROUND

Wireless devices are becoming widely prevalent and are increasingly using wireless channels. The 3^{rd} Generation Partnership Program (3GPP) is developing one or more standards for wireless communications.

### BRIEF DESCRIPTION OF THE DRAWINGS

FIG. 1 is an example network architecture supporting coexistence of RESTful-based network functions and GraphQL-based network functions, in accordance with one or more example embodiments of the present disclosure.

FIG. 2 is an example network architecture supporting coexistence of RESTful-based network functions and GraphQL-based network functions, in accordance with one or more example embodiments of the present disclosure.

FIG. 3 is an example network architecture with a data service function defined as the network function to provide gateway functionality for data service access, in accordance with one or more example embodiments of the present disclosure.

FIG. 4 is an example graph-based structure to represent network data of multiple domains, in accordance with one or more example embodiments of the present disclosure.

FIG. 5 is an example process in which a service consumer requests a data service producer to retrieve data, in accordance with one or more example embodiments of the present disclosure.

FIG. 6 is an example process in which a service consumer requests a data service producer to create data, in accordance with one or more example embodiments of the present disclosure.

FIG. 7 is an example process in which a service consumer requests a data service producer to update data, in accordance with one or more example embodiments of the present disclosure.

FIG. 8 is an example process in which a service consumer requests a data service producer to delete data, in accordance with one or more example embodiments of the present disclosure.

FIG. 9 is an example process in which a service consumer requests a data service producer to subscribe to a notification of data change, in accordance with one or more example embodiments of the present disclosure.

FIG. 10 is an example process in which a service consumer requests a data service producer to subscribe to a notification of data change, in accordance with one or more example embodiments of the present disclosure.

FIG. 11 illustrates a flow diagram of illustrative process for supporting coexistence of RESTful-based network functions and GraphQL-based network functions, in accordance with one or more example embodiments of the present disclosure.

FIG. 12 illustrates a network, in accordance with one or more example embodiments of the present disclosure.

FIG. 13 schematically illustrates a wireless network, in accordance with one or more example embodiments of the present disclosure.

FIG. 14 is a block diagram illustrating components, in accordance with one or more example embodiments of the present disclosure.

FIG. 15 illustrates a network, in accordance with one or more example embodiments of the present disclosure.

FIG. 16 illustrates a simplified block diagram of artificial (AI)-assisted communication between a user equipment and a radio access network, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Wireless devices may operate as defined by technical standards. For cellular telecommunications, the 3rd Generation Partnership Program (3GPP) define communication techniques, including for communications among core network functions. For example, the service-based architecture of the 5G core network adopts the REST paradigm for communications among core network functions, which makes the creation and deployment of distributed services flexible and scalable.

However, for data query (e.g., retrieve data) and modification (e.g., add, update, delete data) services, the following challenges exist:

Over-fetching: A NF service consumer cannot specify the exact data it needs in a query. The response returns data which may result in performance, efficiency and security issues. For example:

Consumer NF sends a REST request to UDM to Retrieve UeContextInSmfData. The response returns the whole structured data rather than the exact data that consumer NF needs.

As a security issue, If an NSSAAF wants to know the serving AMF of a UE, it performs Nudm_UECM_Get operation and is presented with UE's entire AMF registration resource representation in UDM. This can result in potential privacy violation.

Under-fetching: A NF service consumer cannot fetch all data by a single request. For example, to obtain the subscription data during a registration procedure, AMF needs to send multiple requests to UDM to fetch all the needed data.

The 6G system may integrate communication, computing, and data services into its scope. The 6G system needs to consider new API technology in SBA (service-based architecture) to address the above issues for data query and manipulation services.

GraphQL is a query language for the SBA application programming interface (API) and provides a more efficient interface between clients and servers for querying and manipulating data. The GraphQL technology can be adopted as new API technology in 6G SBA. At the same time, because not all NF APIs will benefit in the same way from GraphQL, REST and GraphQL can co-exist. The key features of GraphQL include:

Transport-layer agnostic: A GraphQL server potentially could work based on protocols other than HTTP, like WebSockets or the lower-level TCP.

Data Source(s) agnostic: GraphQL is database agnostic and can be used with any kind of database or even no database at all, for example, remote APIs, and local cache.

A strong typed language: Each type of data such as integer, character, etc. is predefined in the language.

No more over- and under fetching:

Over-fetching is fetching too much data, meaning there is data in the response a client doesn't use. Using GraphQL, a client can specify the data needed in a query. The structure of the server's response follows precisely the nested structure defined in the query.

Under-fetching is not having enough data with a call to an endpoint, forcing a client to call a second endpoint. In GraphQL, only one URI is used to aggregate multiple requests for different resources.

The present disclosure adopts GraphQL in 6G SBA for data query and manipulation services. The present disclosure also provides solutions about the technical realization of GraphQL in SBA.

In Restful, there are some ways to improve the efficiency of data retrieval by using HTTP methods, as shown below:

To mitigate over-fetch, a new query parameter “fields” in HTTP URL is defined to carry the identities of the attributes to be retrieved.

To mitigate under-fetch, bulk (or batching) operations are used to act on more than one resource in a single request.

However, the “fields” parameter attaching to the end of a URL has the disadvantage that practical limitation about the maximum length of the URL is always imposed by client implementation. This will bring scalability problems, that is, only a limited number of attributes are allowed to be obtained via the URL. In addition, only a few NFs and NF services support the functionality, for example, UDR. In addition, the batch operation is not standardized in 3GPP and is implementation-specific, which leads to interoperability issues.

It is therefore proposed in the present disclosure to enable GraphQL API in B5G/6G SBA to provide more efficient data query and manipulation services as an alternative for RESTful APIs.

To enable GrapQL in SBA, there are three options:

Option 1: Use GraphQL API for the NF paired with a data repository.

Option 2: Use GraphQL API for the NF services related to storage and retrieval.

Option 3: A unified mediation NF with GraphQL API.

Option 1: Use GraphQL API for the NF paired with a data repository.

If NF mainly supports data query and manipulation functionalities, it is always implemented by pairing with a database (e.g., MySQL, etc.), for example, UDR (Unified Data Repository), UDSF (Unstructured Data Storage Function), etc. In this option, such NF can use GraphQL to define its schema and expose data query and manipulation services with its GraphQL API and endpoint.

GraphQL API is only applied for the NF, which mainly offers data query and manipulation capabilities, such as UDR, UDSF, etc.

To access services of GraphQL NF, Restful-based NF consumers need to support GraphQL Client functionalities which adds implementation complexity. The issue can be mitigated with some platform technology, for example, by using a service that can decouple the message translations and protocol conversions from the application.

Option 2: Use GraphQL API for the NF services related to data query and manipulation.

Some NFs support not only various communication-related management and control functionalities but also query, manipulation, and subscription of various dynamic data, for example:

NWDAF's Nnwdaf_AnalyticsInfo Service exposes two endpoints: /analytics and /context to provide data query services.

SMF's Nsmf_PDUSession Service exposes the endpoint “/sm contexts/{smContextRef}/retrieve” for a consumer NF to retrieve the context of SM.

NEF's Nnef_PFDmanagement Service exposes the endpoints (e.g., “/applications”, “/applications/{appId}”, “/subscriptions”, “/subscriptions/{subscriptionId}”, . . . etc.) to provide data retrieval, updating and subscription services for external users.

For such NFs, only service operations for data query and manipulation are designed with GraphQL API. For the other types of services, the NFs still use RESTful API. —This option has similar issues with option (e.g., service framework complexity). Some platform technology may be implemented for mitigation.

Option 3: A unified mediation network function with GraphQL.

In this option, the GraphQL-based NF plays as a unified data service API gateway to integrate various NFs and data service instances behind a single, coherent Graph API. The data service function (DSF) may be defined as the network function to provide gateway functionality for data service access, and therefore may be designed as a unified mediation network function.

As a result, data service consumers will reach DSF to fetch all the data they need. DSF is then responsible for:

Single entry endpoint for accessing all the data sources by consolidating all schemas into one schema.

Interacting with different API schema-based data sources. (various NFs providing data query and manipulation services, external data sources, etc.)

Fetching the data and responding in the GraphQL format.

In addition, DSF provides legacy gateway functions, such as security, metrics, and access control functionalities.

This may apply to data query/manipulation services. For other services provided by DSF, RESTful may still be used.

The GraphQL protocol for the service-based interface is shown in the below Table 1.

TABLE 1
GraphQL Protocol for Service-Based Interface

| Layer | Description |
|---|---|
| GraphQL Application | The service-based interface uses HTTP/2 |
| | protocol with a serialization protocol, such |
| | as JSON. |
| Serialization | JSON |
| HTTP/2 or HTTP/3 | Optional, GraphQL message can be carried |
| | directly in an available transport protocol. |
| Security | TLS or QUIC can be used. |
| Transport | Any available network protocol can be |
| | used, for example, TCP, UDP, QUIC, etc. |
| IP | |
| L2 | |

In 5G, a JavaScript Object Notation (JSON) format may be used as a serialization protocol. 6G GraphQL API still uses JSON as a serialization format. The following JSON values could be used to encode the related GraphQL values as shown in Table 2 below.

TABLE 2
JSON Serialization Format of GraphQL Values

| GraphQL Value | JSON Value |
|---|---|
| Map | Object |
| List | Array |
| Null | null |
| String | String |
| Boolean | true or false |
| Int | Number |
| Float | Number |
| Enum Value | String |

GraphQL API may use the same HTTP/Transport protocol as 5G SBA. The default port number may be different from the default one used by RESTful API.

GraphQL API may use the same HTTP/Transport layer security mechanism as 5G SBA.

In 5G, the OpenAPI Specification is used as schema definition language (e.g., Interface Definition Language (IDL)). The GraphQL specification has its schema definition language to define a schema and store it as a string. The syntax is specified as the official GraphQL specification.

For 5G SBA Restful, resources are either individual resources or structured resources that can contain child resources. For 6G, GraphQL may only expose one URI for an API so that resource URI structure is not needed. For example, The REST API for Nudm_UEContextManagement has numerous resource URIs as shown below:
/nudm-uecm/v1/{ueld}/registrations/amf-3gpp-access
/nudm-uecm/v1/{ueld}/registrations/amf-non-3gpp-access
/nudm-uecm/v1/{ueld}/registrations/smf-registrations/{pduSessionld}
/nudm-uecm/v1/{ueld}/registrations/smsf-3gpp-access
/nudm-uecm/v1/{ueld}/registrations/nwdaf-registrations
. . .

GraphQL SDL specifies an object to represent the resources that can be accessed. An object can contain a list of fields, which are specifically typed. The 6G GraphQL API has a single endpoint for each API. Below is an example of Nudm_UEContextManagement:
/nudm-uecm/graphql
. . .

The request URI may have the simplified structure defined below:
{apiRoot}/<apiName>/graphql

The {apiRoot} shall be set as the same definition with 5G SBA Restful.

The <apiName> shall define the name of the API.

The /graphql is the only URI used to aggregate multiple requests for different resources for the API.

For 5G SBA Restful, each service operation for request/response communication may be mapped to one of HTTP-based CRUD methods (e.g., GET, POST, PATCH, DELETE . . . etc.). For 6G SBA, GraphQL special types (e.g., Query/Mutation/subscription) for service operations may be carried in the HTTP body with a JSON data format or other available transport protocol and data formats. The following HTTP methods are specified:

The HTTP Method may use “GET” for all the service requests for data query (retrieve data).

The HTTP Method may use “POST” for all the service requests for data manipulation (add, update, delete data) and subscription/notification.

The transport protocol for the notification could be either web socket, HTTP, or other protocols (e.g., a service producer can obtain the notification endpoint information of service consumer from NRF).

In 5G SBI, the simple data types (e.g., string, integer, number, Boolean, Bytes) and enumerations can be referenced from structured data types. The GraphQL syntax may be reused for the simple data types and enumerations as shown below in Table 3:

TABLE 3
GraphQL Syntax for RESTful and GraphQL Types

| RESTful | GraphQL | |
|---|---|---|
| Types | Types | GraphQL Syntax |
| String | String | The String scalar type represents textual data, |
| | Scalar | represented as a sequence of Unicode code |
| | Type | points. |
| Integer | Int Scalar | The Int scalar type represents a signed 32-bit |
| | Type | numeric non-fractional value. |
| Number | Float | The Float scalar type represents signed double- |
| | Scalar | precision finite values as specified by IEEE 754 |
| | Type | |
| Boolean | Boolean | The Boolean scalar type represents true or false |
| | Scalar | |
| | Type | |
| Enum | Enums | The Enum types describe the set of possible |
| | | values. |
| N/A | ID | The ID scalar type represents a unique identifier, |
| | | often used to re-fetch an object or as the key for |
| | | a cache. It shall be string values of a format like |
| | | GUID |

In 5G, the structured data types may represent an object which can be a resource or sub-resource. For 6G GraphQL-based API, a single graph-structured data model may be used to represent the resources of multiple domains.

An example graph-based structure to represent network data of multiple domains may use the following GraphQL data types:

“““
Data Network
”””
type DataNetwork {
name: String
}
“““
AMF
”””
type AMF {
amfNFInstanceId: String
amfRegionId: Int
supportedGuamiList: [String]
supportedTAIList: [String]!
servingUserList: [MobileUser]
}
“““
SMF
”””
type SMF {
smfNFInstanceId: String
supportedAccessType: [String]
supportedTAIList: [String]!
servingPDUSessionList: [PDUSession]
associatedUPFList: [UPF]
}
“““
UPF
”””
type UPF {
upfNFInstanceId: String
supportedPDUSessionType: [String]!
supportedDNNList: [DataNetwork]
associatedSMFList: [SMF]
servingPDUSessionList: [PDUSession]
}
type PDUSession {
PduSessionId: Int
UEId: MobileUser
ConnectedDataNetwork: DataNetwork
}
“““
Mobile User
”””
type MobileUser {
imsi: String
supi: String
policyUmDataLimits: [Int]
registeredAmf: [AMF]
registeredSmf: [SMF]
isInitialRegistration: Boolean
isEmergencyRegistration: Boolean
requestedPduSession: [PDUSession]
}

There may be a scenario when a service consumer (e.g., AF) sends a request to a data service producer to retrieve data. The request may specify the data fields to “get.” The process flow may be as follows:

The service consumer (e.g. AF) sends a GET request to the GraphQL endpoint of the data service producer, with a JSON-encoded body containing structured fields to query.

The data service NF producer has a single GraphQL endpoint no matter what operation is performed.

In contrast to HTTP method determining the operation performed in REST, query type in the JSON-encoded body determines the get operation in GraphQL. Here the HTTP method is “GET”.

The query naming shall follow regular GraphQL naming conventions, for example name verb first and the object then. For example queryRegistrationInformation.

The query could have several arguments to filter the data. The query contains some data fields where the service consumer specifies the data it wants the service producer to return.

(2a) On success, the data service producer responds with “200 OK” with the message body containing only the data that is specified by the request.

(2b) If the query in the request body is malformed or includes a schema field that doesn't exist, HTTP status code “400 Bad Request” should be returned including additional error information in the response body (in the “errors” field).

(2c) Ifusing not allowed HTTP method, HTTP status code “405 Method Not Allowed” should be returned including additional error information in the response body (e.g., in the “errors” field). For other failures, HTTP error status code may be returned including additional error information in the response body (e.g., in the “errors” field).

There may also be a scenario in which the service consumer (e.g., AF) sends a request to the data service provider to create data, and the request may specify which data fields to create. The process flow may be as follows:

The service consumer (e.g., AF) sends a POST request to the GraphQL endpoint of the data service producer, with a JSON-encoded body containing structured fields to create.

The data service NF producer has a single GraphQL endpoint no matter what operation is performed.

In contrast to HTTP method determining the operation performed in REST, mutation type in the JSON-encoded body determines the data create operation performed in GraphQL. So the HTTP method is “POST”. The create operation may contain several mutations that will be wrapped in a structure.

The mutation naming shall follow regular GraphQL naming conventions, for example name verb first and the object then. For example createRegistrationInformation.

The mutation only has one input argument and input will always be an input object composed of input data fields to create.

The response of the mutation contains some data fields where the service consumer specifies the data it wants the service producer to return after the creation is performed. for example, the last values of the added data fields.

(2a) On success, the data service producer responds with “201 Created” with the message body containing only the data that is requested to return after the creation is performed.

(2b) On failure, the HTTP error status code should be returned including additional error information in the response body (e.g., in the “errors” field). For example, if the mutation in the request body is malformed or includes a schema field that does not exist, the HTTP status code “400 Bad Request” should be returned including additional error information in the response body (e.g., in the “errors” field).

There may be a scenario in which the service consumer (e.g., AF) sends a request to the data service producer to update data, and the request may specify which data fields to update. The process flow may be as follows:

The service consumer (e.g., AF) sends a POST request to the GraphQL endpoint of the data service producer, with a JSON-encoded body containing structured fields to update.

The data service NF producer has a single GraphQL endpoint no matter what operation is performed.

In contrast to HTTP method determining the operation performed in REST, the mutation type in the JSON-encoded body determines the data update operation performed in GraphQL. So the HTTP method is “POST”. The update operation may contain several mutations that will be wrapped in a structure.

The mutation naming shall follow regular GraphQL naming conventions, for example name verb first and the object then. For example updateRegistrationInformation.

A mutation only has one input argument and input will always be an input object composed of input data fields to update.

The response of mutation contains some data fields where the service consumer specifies the data it wants the service producer to return after the update is performed, for example, the last values of the updated data fields.

(2a) On success, the data service producer responds with “200 OK” with the message body containing only the data that is requested to return after the update is performed.

(2b) On failure, the HTTP error status code should be returned including additional error information in the response body (e.g., in the “errors” field), for example, if the mutation in the request body is malformed or includes a schema field that does not exist, HTTP status code “400 Bad Request” should be returned including additional error information in the response body (e.g., in “errors” field).

There may be a scenario in which the service consumer (e.g., AF) sends a request to the data service producer to delete data, and the request may specify which data fields to delete. The process flow may be as follows:

The service consumer (e.g., AF) sends a POST request to the GraphQL endpoint of the data service producer, with a JSON-encoded body containing structured fields to delete.

The data service NF producer has a single GraphQL endpoint no matter what operation is performed.

In contrast to HTTP method determining the operation performed in REST, mutation type in the JSON-encoded body determines the data delete operation performed in GraphQL. So the HTTP method is “POST”. The delete operation may contain several mutations that will be wrapped in a structure.

The mutation naming shall follow regular GraphQL naming conventions, for example name verb first and the object then. For example deleteRegistrationInformation.

The mutation only has one input argument and input will always be an input object composed of input data fields to delete.

The response of the mutation contains some data fields where the service consumer specifies the data it wants the service producer to return after the delete is performed, for example, deleted object UUID.

(2a) The data service producer responds with “200 OK” with the message body containing only the data that is requested to return after the delete is performed.

(2b) n failure, the HTTP error status code should be returned including additional error information in the response body (e.g., in the “errors” field). For example, if the mutation in the request body is malformed or includes a schema field that doesn't exist, the HTTP status code “400 Bad Request” should be returned including additional error information in the response body (e.g., in the “errors” field).

There are service operation options for the scenario in which the service consumer (e.g., AF) sends a request to the data service producer to subscribe to the notification of a data change.

The first option uses a Callback URI in the subscription request according to the following process flow:

The service consumer (e.g., AF) sends a POST request to the GraphQL endpoint of the data service producer, with a JSON-encoded body containing structured fields to delete.

The data service NF producer has a single GraphQL endpoint no matter what operation is performed.

In contrast to HTTP method determining the operation performed in REST, the subscription type in the JSON-encoded body determines the data delete operation performed in GraphQL. So the HTTP method is “POST.”

The subscription naming shall follow regular GraphQL naming conventions, for example name verb first and the object then. For example subscribeRegistrationInformation.

The subscription shall have several arguments to filter the data to subscribe. The subscription contains some data fields where the service consumer specifies the data it wants to receive after the data changes.

The subscription shall have one argument for callback URI used by data change notification.

(2a) On success, the data service producer responds with “200 OK” with the message body containing only the current data values.

(2b) On failure, the HTTP error status code should be returned including additional error information in the response body (e.g., in the “errors” field).

(3) The service producer sends a POST request to the callback URI. The message body contains only the data that is requested to return after the data changes.

The second option is to obtain a Callback URI from the NRF according to the following process flow:

The service consumer (e.g., AF) registers to NRF with its profile which contains the default callback URI.

The service consumer (e.g., AF) sends a POST request to the GraphQL endpoint of the data service producer, with a JSON-encoded body containing structured fields to delete.

The data service NF producer has a single GraphQL endpoint no matter what operation is performed.

In contrast to the HTTP method determining the operation performed in REST, the subscription type in the JSON-encoded body determines the data delete operation performed in GraphQL. So the HTTP method is “POST.”

The subscription naming shall follow regular GraphQL naming conventions, for example, name verb first and the object then. For example subscribeRegistrationInformation.

The subscription shall have several arguments to filter the data to subscribe. The subscription contains some data fields where the service consumer specifies the data it wants to receive after the data changes.

The subscription shall have one argument to represent the subscriber's NF instance information, including NF type, NF instance ID, etc. The information will be used by the service producer.

(3) The service producer (e.g., UDM) queries NRF for the NF profile of the service consumer to obtain the default callback URI.

(4a) On success, the data service producer responds with “200 OK” with the message body containing only the data that is requested to return after the data changes.

(4b) On failure, the HTTP error status code should be returned including additional error information in the response body (e.g., in the “errors” field). For example, if unsuccessfully obtaining callback URI from the NRF, HTTP status code “500 Internal Server Error” should be returned including additional error information in the response body (e.g., in the “errors” field).

(5) The service producer sends a POST request to the callback URI. The message body contains only the data that is requested to return after the data changes.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

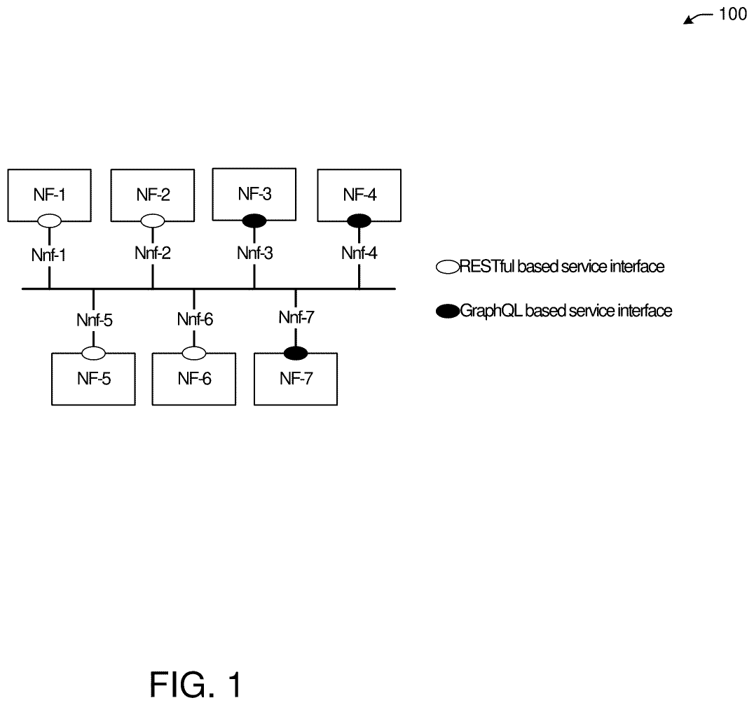

FIG. 1 is an example network architecture 100 supporting coexistence of RESTful-based network functions and GraphQL-based network functions, in accordance with one or more example embodiments of the present disclosure.

Referring to FIG. 1, the network architecture 100 may be a core network architecture with multiple network functions (e.g., NF #1-NF #7), each using a network interface (e.g., Nnf #1-Nnf #7), some of which may be RESTful-based service interfaces, and some of which may be GraphQL-based service interfaces.

If NF mainly supports data query and manipulation functionalities, it is always implemented by pairing with a database (e.g., MySQL, etc.), for example, UDR (Unified Data Repository), UDSF (Unstructured Data Storage Function), etc. In this option, such NF can use GraphQL to define its schema and expose data query and manipulation services with its GraphQL API and endpoint.

GraphQL API is only applied for the NF, which mainly offers data query and manipulation capabilities, such as UDR, UDSF, etc.

To access services of GraphQL NF, Restful-based NF consumers need to support GraphQL Client functionalities which adds implementation complexity. The issue can be mitigated with some platform technology, for example, by using a service that can decouple the message translations and protocol conversions from the application.

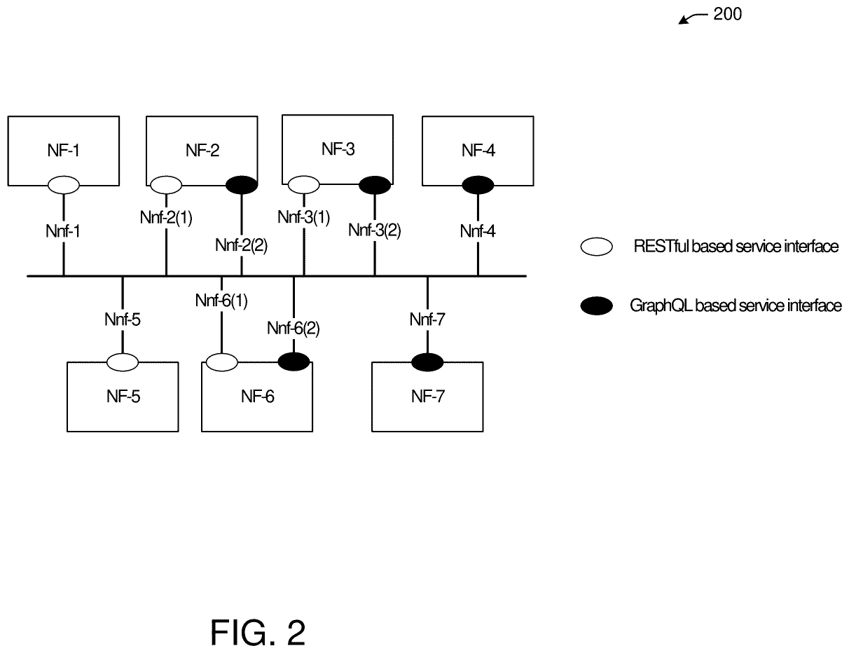

FIG. 2 is an example network architecture 200 supporting coexistence of RESTful-based network functions and GraphQL-based network functions, in accordance with one or more example embodiments of the present disclosure.

Referring to FIG. 2, the network architecture 200 may be a core network architecture with multiple network functions (e.g., NF #1-NF #7), each using one or more network interfaces, some of which may be RESTful-based service interfaces (e.g., for communication control services), and some of which may be GraphQL-based service interfaces (e.g., for data query and manipulation services). For example, NF #1 may use interface Nnf #1 as a RESTful-based interface. NF #2 may use Nnf #2(1) as a RESTful-based interface and interface Nnf #2(2) as a GraphQL-based interface. NF #3 may use Nnf #3(1) as a RESTful-based interface and interface Nnf #3(2) as a GraphQL-based interface. NF #4 may use interface Nnf #4 as a GraphQL-based interface. NF #5 may use interface Nnf #5 as a RESTful-based interface. NF #6 may use Nnf #6(1) as a RESTful-based interface and interface Nnf #6(2) as a GraphQL-based interface. NF #7 may use interface Nnf #7 as a GraphQL-based interface.

Some NFs support not only various communication-related management and control functionalities but also query, manipulation, and subscription of various dynamic data, for example:

NWDAF's Nnwdaf_AnalyticsInfo Service exposes two endpoints: /analytics and /context to provide data query services

SMF's Nsmf_PDUSession Service exposes the endpoint “/sm contexts/{smContextRef}/retrieve” for a consumer NF to retrieve the context of SM.

NEF's Nnef_PFDmanagement Service exposes the endpoints (e.g., “/applications”, “/applications/{appId}”,”/subscriptions”, “/subscriptions/{subscriptionId}”, . . . etc.) to provide data retrieval, updating and subscription services for external users.

For such NFs, only service operations for data query and manipulation are designed with GraphQL API. For the other types of services, the NFs still use RESTful API. —This option has similar issues with option (e.g., service framework complexity). Some platform technology may be implemented for mitigation.

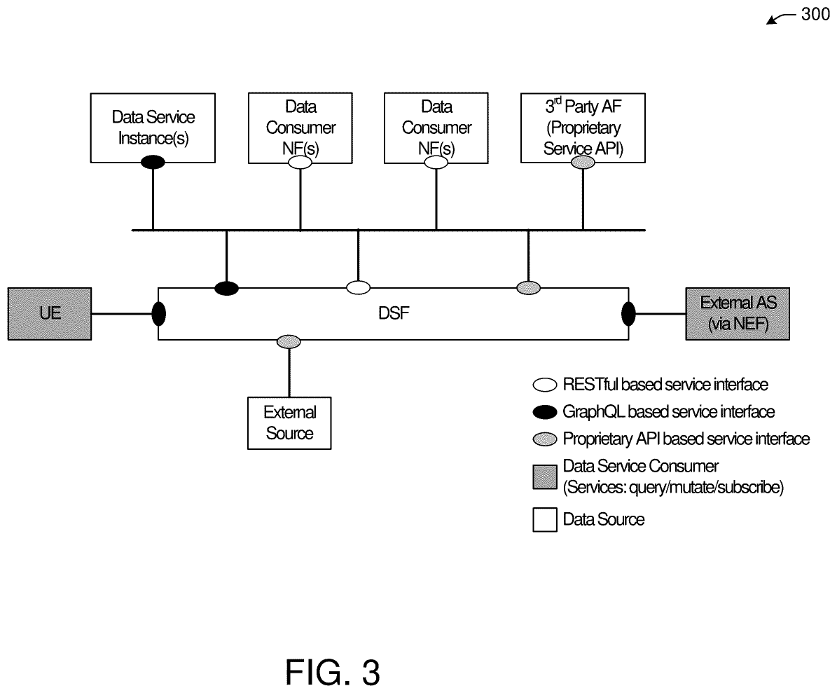

FIG. 3 is an example network architecture 300 with a data service function defined as the network function to provide gateway functionality for data service access, in accordance with one or more example embodiments of the present disclosure.

Referring to FIG. 3, the network architecture 300 may include a core network, including data service instances, data consumer NFs, third party AFs (e.g., with proprietary service APIs), a DSF, a UE, an external AS (via the NEF), and external source. The data consumer NFs and DSF may use a RESTful-based service interface. The data service instances and the DSF may use a GraphQL-based service interface. The third party AF and DSF may use a prioprietary API-based service interface. The UE and external As may be data service consumers. The data service instances, the data consumer NFs, the third party AF, and the external source may be data sources.

In this option, the GraphQL-based NF plays as a unified data service API gateway to integrate various NFs and data service instances behind a single, coherent Graph API. The data service function (DSF) may be defined as the network function to provide gateway functionality for data service access, and therefore may be designed as a unified mediation network function.

As a result, data service consumers will reach DSF to fetch all the data they need. DSF is then responsible for:

Single entry endpoint for accessing all the data sources by consolidating all schemas into one schema.

Interacting with different API schema-based data sources. (various NFs providing data query and manipulation services, external data sources, etc.)

Fetching the data and responding in the GraphQL format.

In addition, DSF provides legacy gateway functions, such as security, metrics, and access control functionalities.

This may apply to data query/manipulation services. For other services provided by DSF, RESTful may still be used.

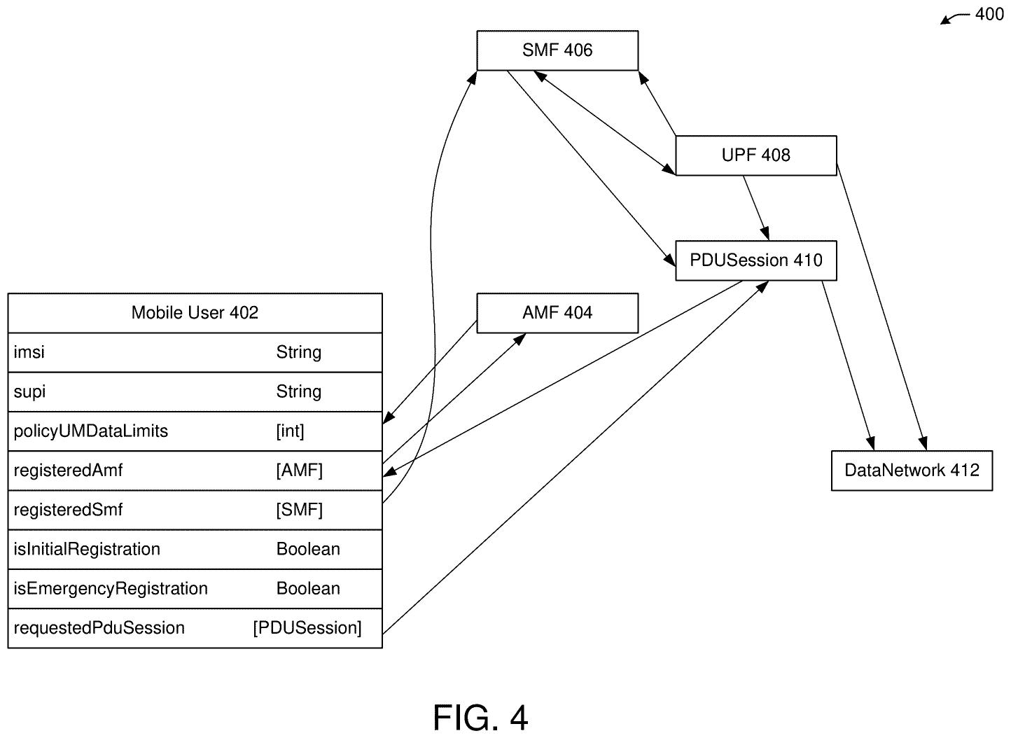

FIG. 4 is an example graph-based structure 400 to represent network data of multiple domains, in accordance with one or more example embodiments of the present disclosure.

In 5G, the structured data types may represent an object which can be a resource or sub-resource. For 6G GraphQL-based API, a single graph-structured data model may be used to represent the resources of multiple domains as shown in FIG. 4.

Referring to FIG. 4, a mobile user 402 may communicate with an AMF 404 and an SMF 406, which may use a UPF 408, may operate a PDUSesssion 410, and may use a DataNetwork 412.

The graph-based structure 400 to represent network data of multiple domains may use the following GraphQL data types:

“““
Data Network
”””
type DataNetwork {
name: String
}
“““
AMF
”””
type AMF {
amfNFInstanceId: String
amfRegionId: Int
supportedGuamiList: [String]
supportedTAIList: [String]!
servingUserList: [MobileUser]
}
“““
SMF
”””
type SMF {
smfNFInstanceId: String
supportedAccessType: [String]
supportedTAIList: [String]!
servingPDUSessionList: [PDUSession]
associatedUPFList: [UPF]
}
“““
UPF
”””
type UPF {
upfNFInstanceId: String
supportedPDUSessionType: [String]!
supportedDNNList: [DataNetwork]
associatedSMFList: [SMF]
servingPDUSessionList: [PDUSession]
}
type PDUSession {
PduSessionId: Int
UEId: MobileUser
ConnectedDataNetwork: DataNetwork
}
“““
Mobile User
”””
type MobileUser {
imsi: String
supi: String
policyUmDataLimits: [Int]
registeredAmf: [AMF]
registeredSmf: [SMF]
isInitialRegistration: Boolean
isEmergencyRegistration: Boolean
requestedPduSession: [PDUSession]
}

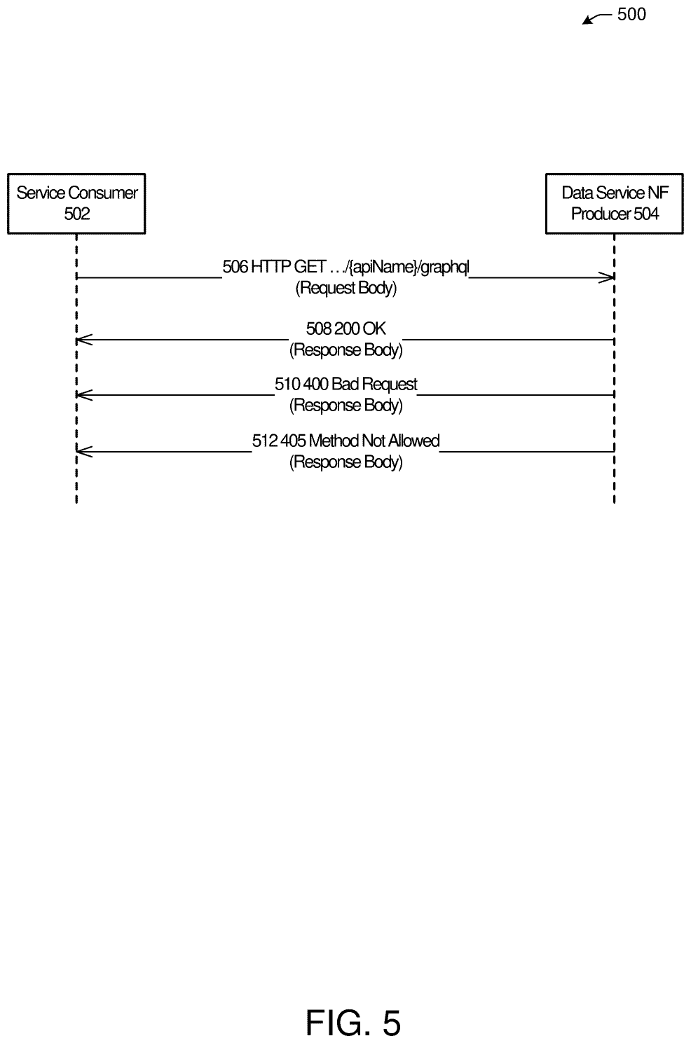

FIG. 5 is an example process 500 in which a service consumer requests a data service producer to retrieve data, in accordance with one or more example embodiments of the present disclosure.

Referring to FIG. 5, a service consumer 502 (e.g., an AF) may communicate with a data service NF producer 504. The process 500 may be as follows:

Step 506: The service consumer 502 sends a GET request to the GraphQL endpoint (e.g., HTTP GET request /{apiName}/graphQL) of the data service NF producer 504, with a JSON-encoded body containing structured fields to query.

The data service NF producer 504 has a single GraphQL endpoint no matter what operation is performed.

In contrast to HTTP method determining the operation performed in REST, query type in the JSON-encoded body determines the get operation in GraphQL. Here the HTTP method is “GET”.

The query naming shall follow regular GraphQL naming conventions, for example name verb first and the object then. For example queryRegistrationInformation.

The query could have several arguments to filter the data. The query contains some data fields where the service consumer specifies the data it wants the service producer to return.

Step 508: On success, the data service NF producer 504 responds with “200 OK” with the message body containing only the data that is specified by the request.

Step 510: If the query in the request body is malformed or includes a schema field that doesn't exist, HTTP status code “400 Bad Request” should be returned including additional error information in the response body (in the “errors” field).

Step 512: If using not allowed HTTP method, HTTP status code “405 Method Not Allowed” should be returned including additional error information in the response body (e.g., in the “errors” field). For other failures, HTTP error status code may be returned including additional error information in the response body (e.g., in the “errors” field).

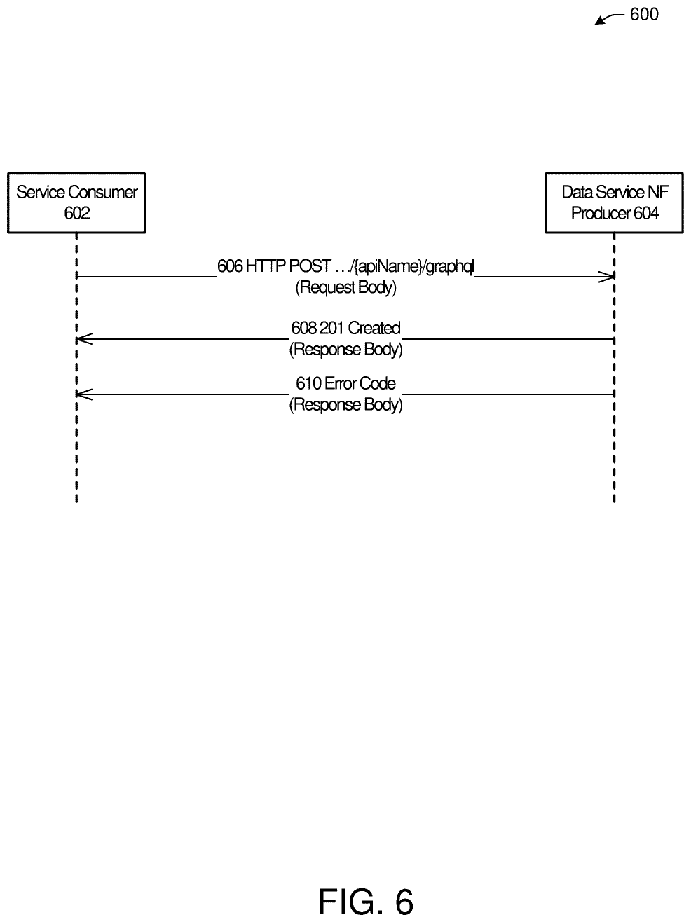

FIG. 6 is an example process 600 in which a service consumer requests a data service producer to create data, in accordance with one or more example embodiments of the present disclosure.

Referring to FIG. 6, a service consumer 602 (e.g., an AF) may communicate with a data service NF producer 604. The process 600 may be as follows:

Step 606: The service consumer 602 sends a POST request to the GraphQL endpoint of the data service NF producer 604 (e.g., HTTP POST request /{apiName}/graphQL), with a JSON-encoded body containing structured fields to create.

The data service NF producer 604 has a single GraphQL endpoint no matter what operation is performed.

In contrast to HTTP method determining the operation performed in REST, mutation type in the JSON-encoded body determines the data create operation performed in GraphQL. So the HTTP method is “POST”. The create operation may contain several mutations that will be wrapped in a structure.

The mutation naming shall follow regular GraphQL naming conventions, for example name verb first and the object then. For example createRegistrationInformation.

The mutation only has one input argument and input will always be an input object composed of input data fields to create.

The response of the mutation contains some data fields where the service consumer specifies the data it wants the service producer to return after the creation is performed. For example, the last values of the added data fields.

Step 608: On success, the data service NF producer 604 responds with “201 Created” with the message body containing only the data that is requested to return after the creation is performed.

Step 610: On failure, the HTTP error status code should be returned including additional error information in the response body (e.g., in the “errors” field). For example, if the mutation in the request body is malformed or includes a schema field that does not exist, the HTTP status code “400 Bad Request” should be returned including additional error information in the response body (e.g., in the “errors” field).

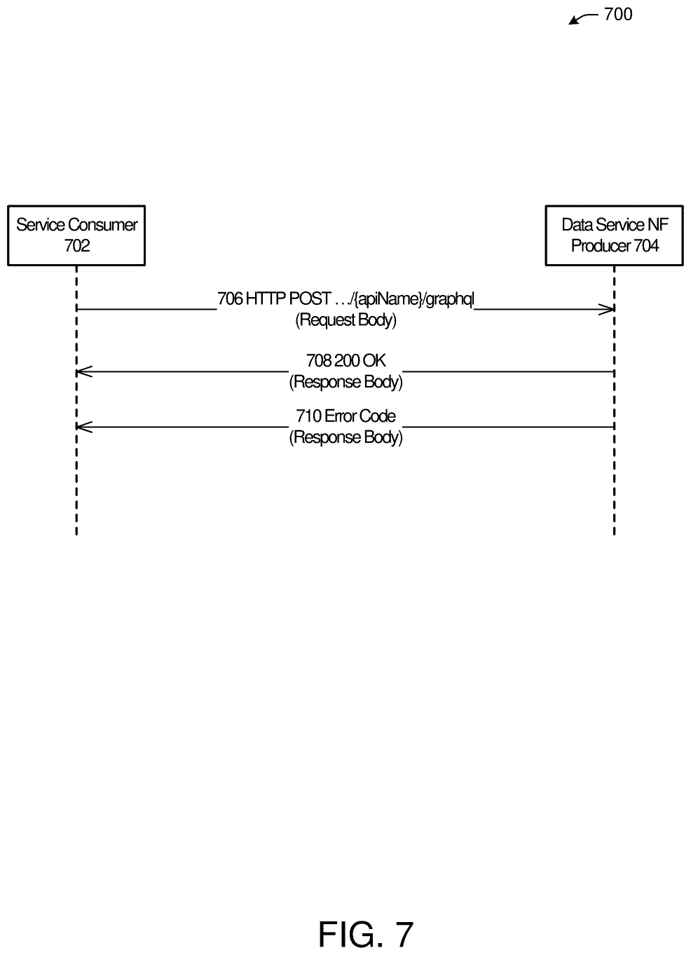

FIG. 7 is an example process 700 in which a service consumer requests a data service producer to update data, in accordance with one or more example embodiments of the present disclosure.

Referring to FIG. 7, a service consumer 702 (e.g., an AF) may communicate with a data service NF producer 704. The process 700 may be as follows:

Step 706: The service consumer 702 sends a POST request to the GraphQL endpoint of the data service NF producer 704 (e.g., HTTP POST request /{apiName}/graphQL), with a JSON-encoded body containing structured fields to update.

The data service NF producer 704 has a single GraphQL endpoint no matter what operation is performed.

In contrast to HTTP method determining the operation performed in REST, the mutation type in the JSON-encoded body determines the data update operation performed in GraphQL. So the HTTP method is “POST”. The update operation may contain several mutations that will be wrapped in a structure.

The mutation naming shall follow regular GraphQL naming conventions, for example name verb first and the object then. For example updateRegistrationInformation.

A mutation only has one input argument and input will always be an input object composed of input data fields to update.

The response of mutation contains some data fields where the service consumer specifies the data it wants the service producer to return after the update is performed, for example, the last values of the updated data fields.

Step 708: On success, the data service NF producer 704 responds with “200 OK” with the message body containing only the data that is requested to return after the update is performed.

Step 710: On failure, the HTTP error status code should be returned including additional error information in the response body (e.g., in the “errors” field), for example, if the mutation in the request body is malformed or includes a schema field that does not exist, HTTP status code “400 Bad Request” should be returned including additional error information in the response body (e.g., in “errors” field).

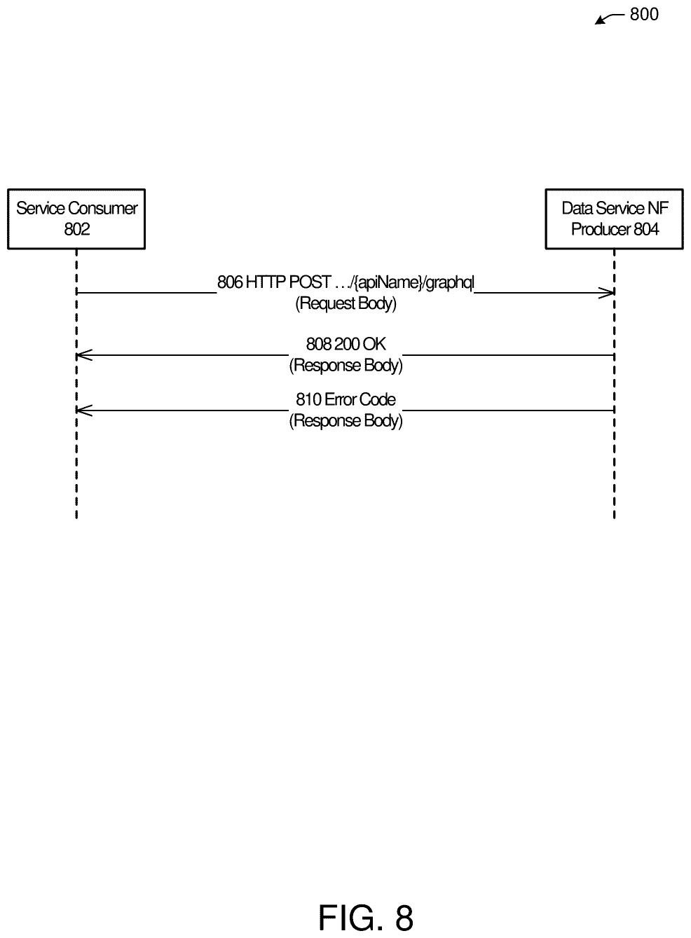

FIG. 8 is an example process 800 in which a service consumer requests a data service producer to delete data, in accordance with one or more example embodiments of the present disclosure.

Referring to FIG. 8, a service consumer 802 (e.g., an AF) may communicate with a data service NF producer 804. The process 800 may be as follows:

Step 806: The service consumer 802 sends a POST request to the GraphQL endpoint of the data service NF producer 804 (e.g., HTTP POST request /{apiName}/graphQL), with a JSON-encoded body containing structured fields to delete.

The data service NF producer 804 has a single GraphQL endpoint no matter what operation is performed.

In contrast to HTTP method determining the operation performed in REST, mutation type in the JSON-encoded body determines the data delete operation performed in GraphQL. So the HTTP method is “POST”. The delete operation may contain several mutations that will be wrapped in a structure.

The mutation naming shall follow regular GraphQL naming conventions, for example name verb first and the object then. For example deleteRegistrationInformation.

The mutation only has one input argument and input will always be an input object composed of input data fields to delete.

The response of the mutation contains some data fields where the service consumer 802 specifies the data it wants the data service NF producer 804 to return after the delete is performed, for example, deleted object UUID.

Step 808: The data service NF producer 804 responds with “200 OK” with the message body containing only the data that is requested to return after the delete is performed.

Step 810: On failure, the HTTP error status code should be returned including additional error information in the response body (in the “errors” field). For example, if the mutation in the request body is malformed or includes a schema field that doesn't exist, the HTTP status code “400 Bad Request” should be returned including additional error information in the response body (in the “errors” field).

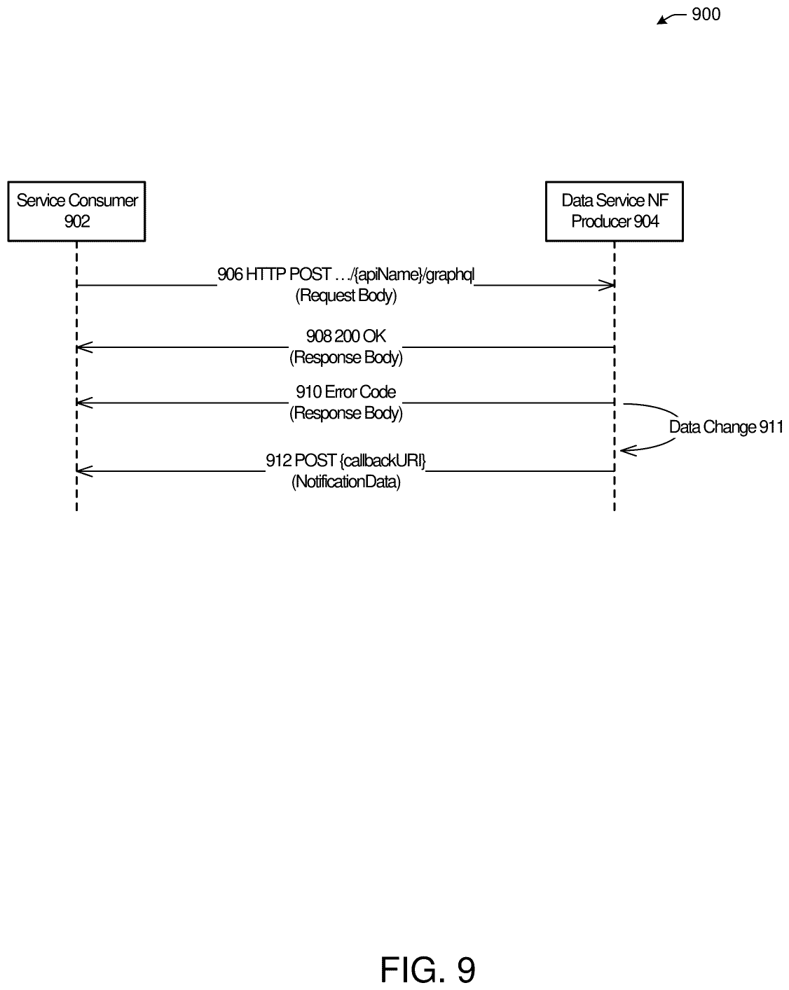

FIG. 9 is an example process 900 in which a service consumer requests a data service producer to subscribe to a notification of data change, in accordance with one or more example embodiments of the present disclosure.

Referring to FIG. 9, a service consumer 902 (e.g., an AF) may communicate with a data service NF producer 904. The process 900 may be as follows:

Step 906: The service consumer 902 sends a POST request to the GraphQL endpoint of the data service NF producer 904 (e.g., HTTP POST request /{apiName}/graphQL), with a JSON-encoded body containing structured fields to delete.

The data service NF producer 904 has a single GraphQL endpoint no matter what operation is performed.

In contrast to HTTP method determining the operation performed in REST, the subscription type in the JSON-encoded body determines the data delete operation performed in GraphQL. So the HTTP method is “POST.”

The subscription naming shall follow regular GraphQL naming conventions, for example name verb first and the object then. For example subscribeRegistrationInformation.

The subscription shall have several arguments to filter the data to subscribe. The subscription contains some data fields where the service consumer specifies the data it wants to receive after the data changes.

The subscription shall have one argument for callback URI used by data change notification.

Step 908: On success, the data service NF producer 904 responds with “200 OK” with the message body containing only the current data values.

Step 910: On failure, the HTTP error status code should be returned including additional error information in the response body (e.g., in the “errors” field).

Step 911: A data change to the subscribed data is detected by the data service NF producer 904, triggering an update to the service consumer 902.

Step 912: The data service producer 904 sends a POST request to the callback URI. The message body contains only the data that is requested to return after the data changes.

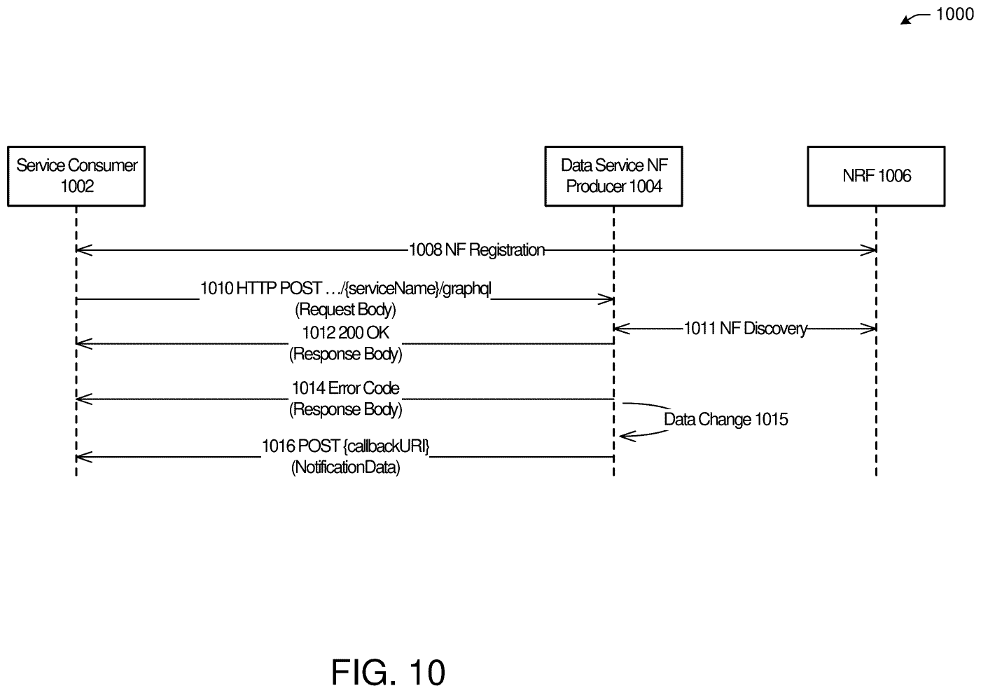

FIG. 10 is an example process 1000 in which a service consumer requests a data service producer to subscribe to a notification of data change, in accordance with one or more example embodiments of the present disclosure.

Referring to FIG. 10, a service consumer 1002 (e.g., an AF) may communicate with a data service NF producer 1004 and a NRF 1006. The process 1000 may be as follows:

Step 1008: The service consumer 1002 registers to the NRF 1006 with its profile which contains the default callback URI.

Step 1010: The service consumer 1002 sends a POST request to the GraphQL endpoint of the data service NF producer 1004 (e.g., HTTP POST request /{apiName}/graphQL), with a JSON-encoded body containing structured fields to delete.

The data service NF producer 1004 has a single GraphQL endpoint no matter what operation is performed.

In contrast to the HTTP method determining the operation performed in REST, the subscription type in the JSON-encoded body determines the data delete operation performed in GraphQL. So the HTTP method is “POST.”

The subscription naming shall follow regular GraphQL naming conventions, for example, name verb first and the object then. For example subscribeRegistrationInformation.

The subscription shall have several arguments to filter the data to subscribe. The subscription contains some data fields where the service consumer 1002 specifies the data it wants to receive after the data changes.

The subscription shall have one argument to represent the data subscriber's NF instance information, including NF type, NF instance ID, etc. The information will be used by the data service NF producer 1004.

Step 1011: The data service NF producer 1004 queries the NRF 1006 for the NF profile of the service consumer 1002 to obtain the default callback URI.

Step 1012: On success, the data service NF producer 1004 responds with “200 OK” with the message body containing only the data that is requested to return after the data changes.

Step 1014: On failure, the HTTP error status code should be returned including additional error information in the response body (e.g., in the “errors” field). For example, if unsuccessfully obtaining callback URI from the NRF, HTTP status code “500 Internal Server Error” should be returned including additional error information in the response body (e.g., in the “errors” field).

Step 1015: A data change to the subscribed data is detected by the data service NF producer 1004, triggering an update to the service consumer 1002.

Step 1016: The data service NF producer 1004 sends a POST request to the callback URI. The message body contains only the data that is requested to return after the data changes.

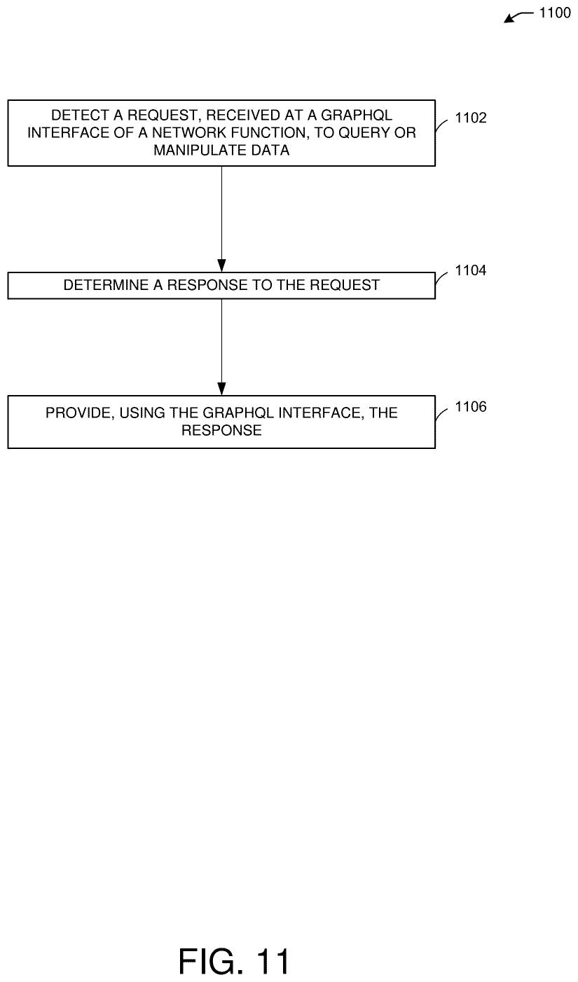

FIG. 11 illustrates a flow diagram of illustrative process 1100 for supporting coexistence of RESTful-based network functions and GraphQL-based network functions, in accordance with one or more example embodiments of the present disclosure.

At block 1102, a NF may detect a request, received at a GraphQL API, from a service consumer, to manipulate or query data (e.g., a HTTP GET or POST request).

At block 1104, the NF may determine a response to the request (e.g., approving the request, notifying of an error, notifying of a modification to subscription data, etc.).

At block 1106, the NF may provide the response using the GraphQL API to the requesting service consumer.

These embodiments are not meant to be limiting.

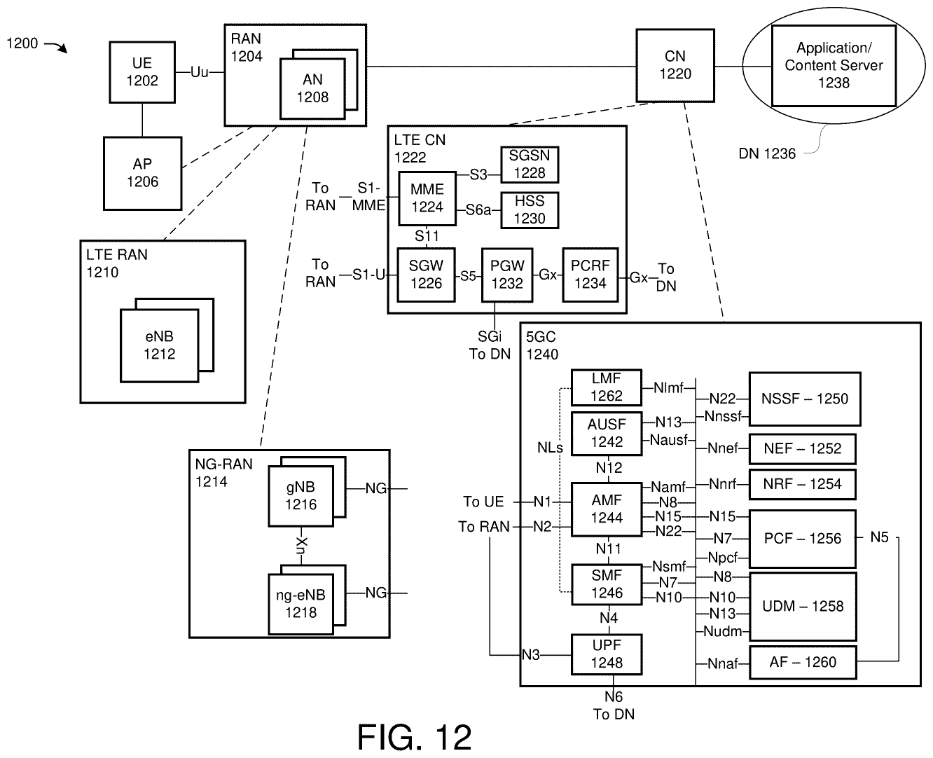

FIG. 12 illustrates a network 1200 in accordance with various embodiments. The network 1200 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 1200 may include a UE 1202, which may include any mobile or non-mobile computing device designed to communicate with a RAN 1204 via an over-the-air connection. The UE 1202 may be communicatively coupled with the RAN 1204 by a Uu interface. The UE 1202 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 1200 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 1202 may additionally communicate with an AP 1206 via an over-the-air connection. The AP 1206 may manage a WLAN connection, which may serve to offload some/all network traffic from the RAN 1204. The connection between the UE 1202 and the AP 1206 may be consistent with any IEEE 802.11 protocol, wherein the AP 1206 could be a wireless fidelity (Wi-Fi®) router. In some embodiments, the UE 1202, RAN 1204, and AP 1206 may utilize cellular-WLAN aggregation (for example, LWA/LWIP). Cellular-WLAN aggregation may involve the UE 1202 being configured by the RAN 1204 to utilize both cellular radio resources and WLAN resources.

The RAN 1204 may include one or more access nodes, for example, AN 1208. AN 1208 may terminate air-interface protocols for the UE 1202 by providing access stratum protocols including RRC, PDCP, RLC, MAC, and LI protocols. In this manner, the AN 1208 may enable data/voice connectivity between CN 1220 and the UE 1202. In some embodiments, the AN 1208 may be implemented in a discrete device or as one or more software entities running on server computers as part of, for example, a virtual network, which may be referred to as a CRAN or virtual baseband unit pool. The AN 1208 be referred to as a BS, gNB, RAN node, eNB, ng-eNB, NodeB, RSU, TRxP, TRP, etc. The AN 1208 may be a macrocell base station or a low power base station for providing femtocells, picocells or other like cells having smaller coverage areas, smaller user capacity, or higher bandwidth compared to macrocells.

In embodiments in which the RAN 1204 includes a plurality of ANs, they may be coupled with one another via an X2 interface (if the RAN 1204 is an LTE RAN) or an Xn interface (if the RAN 1204 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 1204 may each manage one or more cells, cell groups, component carriers, etc. to provide the UE 1202 with an air interface for network access. The UE 1202 may be simultaneously connected with a plurality of cells provided by the same or different ANs of the RAN 1204. For example, the UE 1202 and RAN 1204 may use carrier aggregation to allow the UE 1202 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 1204 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 1202 or AN 1208 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 1204 may be an LTE RAN 1210 with eNBs, for example, eNB 1212. The LTE RAN 1210 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 1204 may be an NG-RAN 1214 with gNBs, for example, gNB 1216, or ng-eNBs, for example, ng-eNB 1218. The gNB 1216 may connect with 5G-enabled UEs using a 5G NR interface. The gNB 1216 may connect with a 5G core through an NG interface, which may include an N2 interface or an N3 interface. The ng-eNB 1218 may also connect with the 5G core through an NG interface, but may connect with a UE via an LTE air interface. The gNB 1216 and the ng-eNB 1218 may connect with each other over an Xn interface.

In some embodiments, the NG interface may be split into two parts, an NG user plane (NG-U) interface, which carries traffic data between the nodes of the NG-RAN 1214 and a UPF 1248 (e.g., N3 interface), and an NG control plane (NG-C) interface, which is a signaling interface between the nodes of the NG-RAN 1214 and an AMF 1244 (e.g., N2 interface).

The NG-RAN 1214 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 1202 can be configured with multiple BWPs where each BWP configuration has a different SCS. When a BWP change is indicated to the UE 1202, the SCS of the transmission is changed as well. Another use case example of BWP is related to power saving. In particular, multiple BWPs can be configured for the UE 1202 with different amount of frequency resources (for example, PRBs) to support data transmission under different traffic loading scenarios. A BWP containing a smaller number of PRBs can be used for data transmission with small traffic load while allowing power saving at the UE 1202 and in some cases at the gNB 1216. A BWP containing a larger number of PRBs can be used for scenarios with higher traffic load.

The RAN 1204 is communicatively coupled to CN 1220 that includes network elements to provide various functions to support data and telecommunications services to customers/subscribers (for example, users of UE 1202). The components of the CN 1220 may be implemented in one physical node or separate physical nodes. In some embodiments, NFV may be utilized to virtualize any or all of the functions provided by the network elements of the CN 1220 onto physical compute/storage resources in servers, switches, etc. A logical instantiation of the CN 1220 may be referred to as a network slice, and a logical instantiation of a portion of the CN 1220 may be referred to as a network sub-slice.

In some embodiments, the CN 1220 may be an LTE CN 1222, which may also be referred to as an EPC. The LTE CN 1222 may include MME 1224, SGW 1226, SGSN 1228, HSS 1230, PGW 1232, and PCRF 1234 coupled with one another over interfaces (or “reference points”) as shown. Functions of the elements of the LTE CN 1222 may be briefly introduced as follows.

The MME 1224 may implement mobility management functions to track a current location of the UE 1202 to facilitate paging, bearer activation/deactivation, handovers, gateway selection, authentication, etc.

The SGW 1226 may terminate an S1 interface toward the RAN and route data packets between the RAN and the LTE CN 1222. The SGW 1226 may be a local mobility anchor point for inter-RAN node handovers and also may provide an anchor for inter-3GPP mobility. Other responsibilities may include lawful intercept, charging, and some policy enforcement.

The SGSN 1228 may track a location of the UE 1202 and perform security functions and access control. In addition, the SGSN 1228 may perform inter-EPC node signaling for mobility between different RAT networks; PDN and S-GW selection as specified by MME 1224; MME selection for handovers; etc. The S3 reference point between the MME 424 and the SGSN 1228 may enable user and bearer information exchange for inter-3GPP access network mobility in idle/active states.

The HSS 1230 may include a database for network users, including subscription-related information to support the network entities' handling of communication sessions. The HSS 1230 can provide support for routing/roaming, authentication, authorization, naming/addressing resolution, location dependencies, etc. An S6a reference point between the HSS 1230 and the MME 1224 may enable transfer of subscription and authentication data for authenticating/authorizing user access to the LTE CN 1220.

The PGW 1232 may terminate an SG1 interface toward a data network (DN) 1236 that may include an application/content server 1238. The PGW 1232 may route data packets between the LTE CN 1222 and the data network 1236. The PGW 1232 may be coupled with the SGW 1226 by an S5 reference point to facilitate user plane tunneling and tunnel management. The PGW 1232 may further include a node for policy enforcement and charging data collection (for example, PCEF). Additionally, the SG1 reference point between the PGW 1232 and the data network 1236 may be an operator external public, a private PDN, or an intra-operator packet data network, for example, for provision of IMS services. The PGW 1232 may be coupled with a PCRF 1234 via a Gx reference point.

The PCRF 1234 is the policy and charging control element of the LTE CN 1222. The PCRF 1234 may be communicatively coupled to the app/content server 1238 to determine appropriate QoS and charging parameters for service flows. The PCRF 1232 may provision associated rules into a PCEF (via Gx reference point) with appropriate TFT and QCI.

In some embodiments, the CN 1220 may be a 5GC 1240. The 5GC 1240 may include an AUSF 1242, AMF 1244, SMF 1246, UPF 1248, NSSF 1250, NEF 1252, NRF 1254, PCF 1256, UDM 1258, and AF 1260 coupled with one another over interfaces (or “reference points”) as shown. Functions of the elements of the 5GC 1240 may be briefly introduced as follows.

The AUSF 1242 may store data for authentication of UE 1202 and handle authentication-related functionality. The AUSF 1242 may facilitate a common authentication framework for various access types. In addition to communicating with other elements of the 5GC 1240 over reference points as shown, the AUSF 1242 may exhibit an Nausf service-based interface.

The AMF 1244 may allow other functions of the 5GC 1240 to communicate with the UE 1202 and the RAN 1204 and to subscribe to notifications about mobility events with respect to the UE 1202. The AMF 1244 may be responsible for registration management (for example, for registering UE 1202), connection management, reachability management, mobility management, lawful interception of AMF-related events, and access authentication and authorization. The AMF 1244 may provide transport for SM messages between the UE 1202 and the SMF 1246, and act as a transparent proxy for routing SM messages. AMF 1244 may also provide transport for SMS messages between UE 1202 and an SMSF. AMF 1244 may interact with the AUSF 1242 and the UE 1202 to perform various security anchor and context management functions. Furthermore, AMF 1244 may be a termination point of a RAN CP interface, which may include or be an N2 reference point between the RAN 1204 and the AMF 1244; and the AMF 1244 may be a termination point of NAS (N1) signaling, and perform NAS ciphering and integrity protection. AMF 1244 may also support NAS signaling with the UE 1202 over an N3 IWF interface.

The SMF 1246 may be responsible for SM (for example, session establishment, tunnel management between UPF 1248 and AN 1208); UE IP address allocation and management (including optional authorization); selection and control of UP function; configuring traffic steering at UPF 1248 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 1244 over N2 to AN 1208; and determining SSC mode of a session. SM may refer to management of a PDU session, and a PDU session or “session” may refer to a PDU connectivity service that provides or enables the exchange of PDUs between the UE 1202 and the data network 1236.

The UPF 1248 may act as an anchor point for intra-RAT and inter-RAT mobility, an external PDU session point of interconnect to data network 1236, and a branching point to support multi-homed PDU session. The UPF 1248 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 1248 may include an uplink classifier to support routing traffic flows to a data network.

The NSSF 1250 may select a set of network slice instances serving the UE 1202. The NSSF 1250 may also determine allowed NSSAI and the mapping to the subscribed S-NSSAIs, if needed. The NSSF 1250 may also determine the AMF set to be used to serve the UE 1202, or a list of candidate AMFs based on a suitable configuration and possibly by querying the NRF 1254. The selection of a set of network slice instances for the UE 1202 may be triggered by the AMF 1244 with which the UE 1202 is registered by interacting with the NSSF 1250, which may lead to a change of AMF. The NSSF 1250 may interact with the AMF 1244 via an N22 reference point; and may communicate with another NSSF in a visited network via an N31 reference point (not shown). Additionally, the NSSF 1250 may exhibit an Nnssf service-based interface.

The NEF 1252 may securely expose services and capabilities provided by 3GPP network functions for third party, internal exposure/re-exposure, AFs (e.g., AF 1260), edge computing or fog computing systems, etc. In such embodiments, the NEF 1252 may authenticate, authorize, or throttle the AFs. NEF 1252 may also translate information exchanged with the AF 1260 and information exchanged with internal network functions. For example, the NEF 1252 may translate between an AF-Service-Identifier and an internal 5GC information. NEF 1252 may also receive information from other NFs based on exposed capabilities of other NFs. This information may be stored at the NEF 1252 as structured data, or at a data storage NF using standardized interfaces. The stored information can then be re-exposed by the NEF 1252 to other NFs and AFs, or used for other purposes such as analytics. Additionally, the NEF 1252 may exhibit an Nnef service-based interface.

The NRF 1254 may support service discovery functions, receive NF discovery requests from NF instances, and provide the information of the discovered NF instances to the NF instances. NRF 1254 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 1254 may exhibit the Nnrf service-based interface.

The PCF 1256 may provide policy rules to control plane functions to enforce them, and may also support unified policy framework to govern network behavior. The PCF 1256 may also implement a front end to access subscription information relevant for policy decisions in a UDR of the UDM 1258. In addition to communicating with functions over reference points as shown, the PCF 1256 exhibit an Npcf service-based interface.

The UDM 1258 may handle subscription-related information to support the network entities' handling of communication sessions, and may store subscription data of UE 1202. For example, subscription data may be communicated via an N8 reference point between the UDM 1258 and the AMF 1244. The UDM 1258 may include two parts, an application front end and a UDR. The UDR may store subscription data and policy data for the UDM 1258 and the PCF 1256, and/or structured data for exposure and application data (including PFDs for application detection, application request information for multiple UEs 1202) for the NEF 1252. The Nudr service-based interface may be exhibited by the UDR to allow the UDM 1258, PCF 1256, and NEF 1252 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 1258 may exhibit the Nudm service-based interface.

The AF 1260 may provide application influence on traffic routing, provide access to NEF, and interact with the policy framework for policy control.

In some embodiments, the 5GC 1240 may enable edge computing by selecting operator/3rd party services to be geographically close to a point that the UE 1202 is attached to the network. This may reduce latency and load on the network. To provide edge-computing implementations, the 5GC 1240 may select a UPF 1248 close to the UE 1202 and execute traffic steering from the UPF 1248 to data network 1236 via the N6 interface. This may be based on the UE subscription data, UE location, and information provided by the AF 1260. In this way, the AF 1260 may influence UPF (re)selection and traffic routing. Based on operator deployment, when AF 1260 is considered to be a trusted entity, the network operator may permit AF 1260 to interact directly with relevant NFs. Additionally, the AF 1260 may exhibit an Naf service-based interface.

The data network 1236 may represent various network operator services, Internet access, or third party services that may be provided by one or more servers including, for example, application/content server 1238.

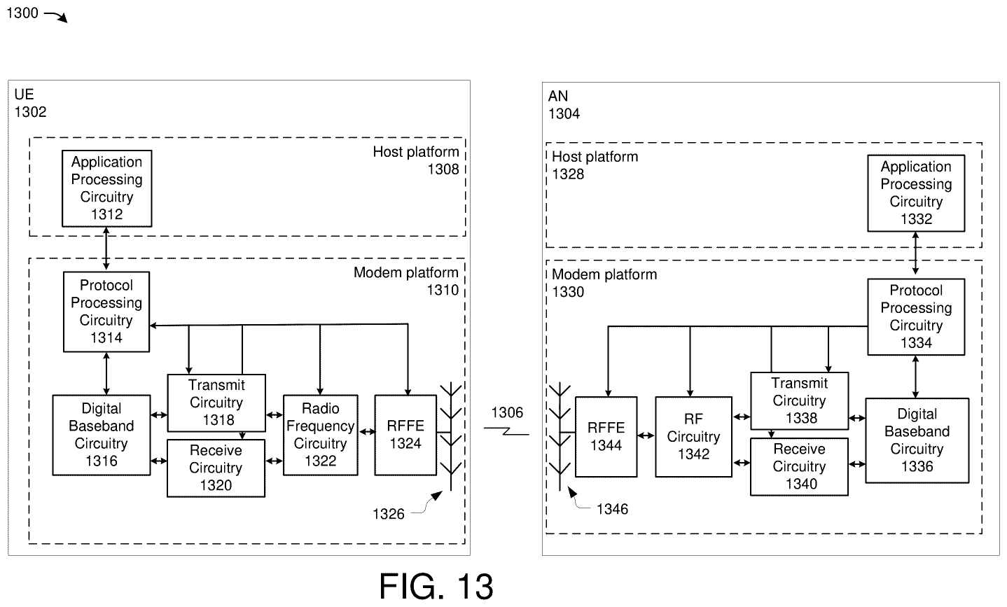

FIG. 13 schematically illustrates a wireless network 1300 in accordance with various embodiments. The wireless network 1300 may include a UE 1302 in wireless communication with an AN 1304. The UE 1302 and AN 1304 may be similar to, and substantially interchangeable with, like-named components described elsewhere herein.

The UE 1302 may be communicatively coupled with the AN 1304 via connection 1306. The connection 1306 is illustrated as an air interface to enable communicative coupling, and can be consistent with cellular communications protocols such as an LTE protocol or a 5G NR protocol operating at mmWave or sub-6 GHz frequencies.

The UE 1302 may include a host platform 1308 coupled with a modem platform 1310. The host platform 1308 may include application processing circuitry 1312, which may be coupled with protocol processing circuitry 1314 of the modem platform 1310. The application processing circuitry 1312 may run various applications for the UE 1302 that source/sink application data. The application processing circuitry 1312 may further implement one or more layer operations to transmit/receive application data to/from a data network. These layer operations may include transport (for example UDP) and Internet (for example, IP) operations

The protocol processing circuitry 1314 may implement one or more of layer operations to facilitate transmission or reception of data over the connection 1306. The layer operations implemented by the protocol processing circuitry 1314 may include, for example, MAC, RLC, PDCP, RRC and NAS operations.

The modem platform 1310 may further include digital baseband circuitry 1316 that may implement one or more layer operations that are “below” layer operations performed by the protocol processing circuitry 1314 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1310 may further include transmit circuitry 1318, receive circuitry 1320, RF circuitry 1322, and RF front end (RFFE) 1324, which may include or connect to one or more antenna panels 1326. Briefly, the transmit circuitry 1318 may include a digital-to-analog converter, mixer, intermediate frequency (IF) components, etc.; the receive circuitry 1320 may include an analog-to-digital converter, mixer, IF components, etc.; the RF circuitry 1322 may include a low-noise amplifier, a power amplifier, power tracking components, etc.; RFFE 1324 may include filters (for example, surface/bulk acoustic wave filters), switches, antenna tuners, beamforming components (for example, phase-array antenna components), etc. The selection and arrangement of the components of the transmit circuitry 1318, receive circuitry 1320, RF circuitry 1322, RFFE 1324, and antenna panels 1326 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 1314 may include one or more instances of control circuitry (not shown) to provide control functions for the transmit/receive components.

A UE reception may be established by and via the antenna panels 1326, RFFE 1324, RF circuitry 1322, receive circuitry 1320, digital baseband circuitry 1316, and protocol processing circuitry 1314. In some embodiments, the antenna panels 1326 may receive a transmission from the AN 1304 by receive-beamforming signals received by a plurality of antennas/antenna elements of the one or more antenna panels 1326.

A UE transmission may be established by and via the protocol processing circuitry 1314, digital baseband circuitry 1316, transmit circuitry 1318, RF circuitry 1322, RFFE 1324, and antenna panels 1326. In some embodiments, the transmit components of the UE 1304 may apply a spatial filter to the data to be transmitted to form a transmit beam emitted by the antenna elements of the antenna panels 1326.

Similar to the UE 1302, the AN 1304 may include a host platform 1328 coupled with a modem platform 1330. The host platform 1328 may include application processing circuitry 1332 coupled with protocol processing circuitry 1334 of the modem platform 1330. The modem platform may further include digital baseband circuitry 1336, transmit circuitry 1338, receive circuitry 1340, RF circuitry 1342, RFFE circuitry 1344, and antenna panels 1346. The components of the AN 1304 may be similar to and substantially interchangeable with like-named components of the UE 1302. In addition to performing data transmission/reception as described above, the components of the AN 1308 may perform various logical functions that include, for example, RNC functions such as radio bearer management, uplink and downlink dynamic radio resource management, and data packet scheduling.

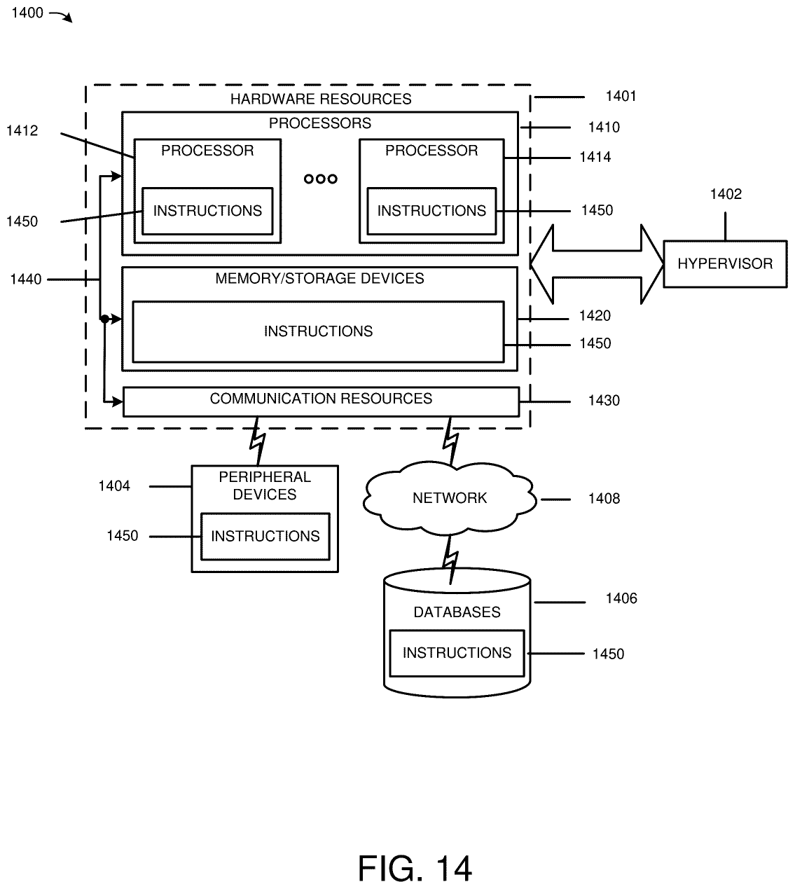

FIG. 14 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 14 shows a diagrammatic representation of hardware resources 1400 including one or more processors (or processor cores) 1410, one or more memory/storage devices 1420, and one or more communication resources 1430, each of which may be communicatively coupled via a bus 1440 or other interface circuitry. For embodiments where node virtualization (e.g., NFV) is utilized, a hypervisor 1402 may be executed to provide an execution environment for one or more network slices/sub-slices to utilize the hardware resources 1400.

The processors 1410 may include, for example, a processor 1412 and a processor 1414. The processors 1410 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 1420 may include main memory, disk storage, or any suitable combination thereof. The memory/storage devices 1420 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1430 may include interconnection or network interface controllers, components, or other suitable devices to communicate with one or more peripheral devices 1404 or one or more databases 1406 or other network elements via a network 1408. For example, the communication resources 1430 may include wired communication components (e.g., for coupling via USB, Ethernet, etc.), cellular communication components, NFC components, Bluetooth® (or Bluetooth® Low Energy) components, Wi-Fi® components, and other communication components.

Instructions 1450 may comprise software, a program, an application, an applet, an app, or other executable code for causing at least any of the processors 1410 to perform any one or more of the methodologies discussed herein. The instructions 1450 may reside, completely or partially, within at least one of the processors 1410 (e.g., within the processor's cache memory), the memory/storage devices 1420, or any suitable combination thereof. Furthermore, any portion of the instructions 1450 may be transferred to the hardware resources 1400 from any combination of the peripheral devices 1404 or the databases 1406. Accordingly, the memory of processors 1410, the memory/storage devices 1420, the peripheral devices 1404, and the databases 1406 are examples of computer-readable and machine-readable media.

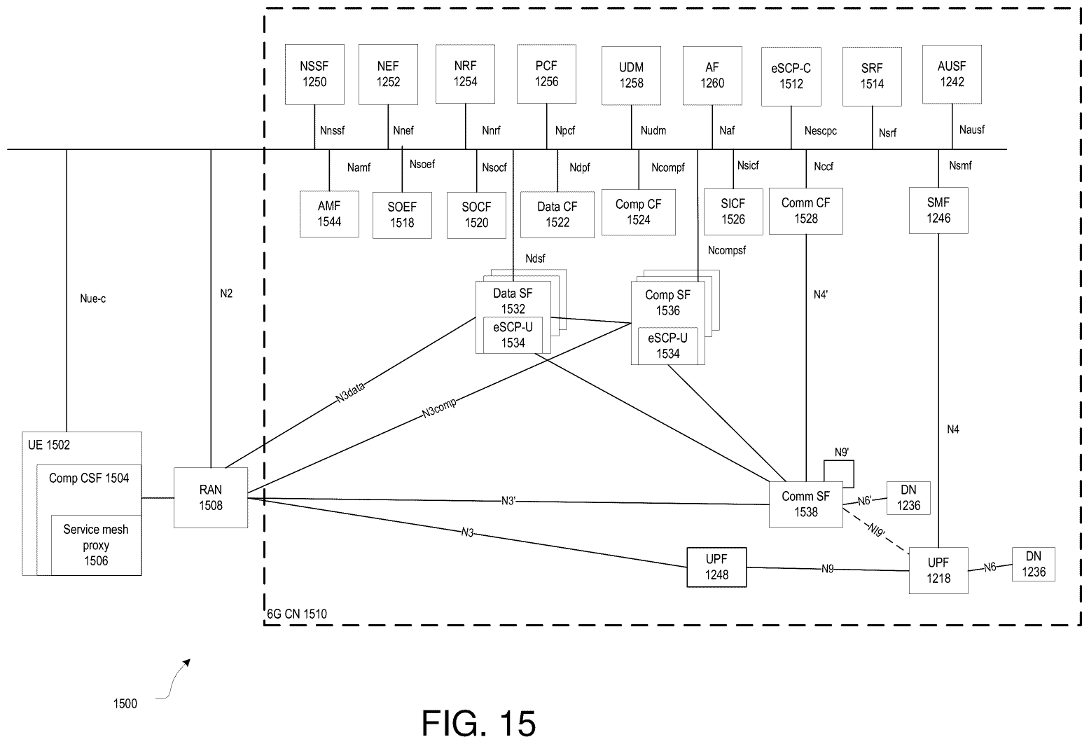

FIG. 15 illustrates a network, in accordance with one or more example embodiments of the present disclosure.

The network 1500 may operate in a matter consistent with 3GPP technical specifications or technical reports for 6G systems. In some examples, the network 1500 may operate concurrently with network 1200. For example, in some examples, the network 1500 may share one or more frequency or bandwidth resources with network 1200. As one specific example, a UE (e.g., UE 1502) may be configured to operate in both network 1500 and network 1200. Such configuration may be based on a UE including circuitry configured for communication with frequency and bandwidth resources of both networks 1200 and 1500. In general, several elements of network 1500 may share one or more characteristics with elements of network 1200. For the sake of brevity and clarity, such elements may not be repeated in the description of network 1500.

The network 1500 may include a UE 1502, which may include any mobile or non-mobile computing device designed to communicate with a RAN 1508 via an over-the-air connection. The UE 1502 may be similar to, for example, UE 1202. The UE 1502 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 15, in some examples the network 1500 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 15, the UE 1502 may be communicatively coupled with an AP such as AP 1206 as described with respect to FIG. 12. Additionally, although not specifically shown in FIG. 15, in some examples the RAN 1508 may include one or more ANs such as AN 1208 as described with respect to FIG. 12. The RAN 1508 and/or the AN of the RAN 1508 may be referred to as a base station (BS), a RAN node, or using some other term or name.

The UE 1502 and the RAN 1508 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 1508 may allow for communication between the UE 1502 and a 6G core network (CN) 1510. Specifically, the RAN 1508 may facilitate the transmission and reception of data between the UE 1502 and the 6G CN 1510. The 6G CN 1510 may include various functions such as NSSF 1250, NEF 1252, NRF 1254, PCF 1256, UDM 1258, AF 1260, SMF 1246, and AUSF 1242. The 6G CN 1510 may additional include UPF 1248 and DN 1236 as shown in FIG. 12.

Additionally, the RAN 1508 may include various additional functions that are in addition to, or alternative to, functions of a legacy cellular network such as a 4G or 5G network. Two such functions may include a Compute Control Function (Comp CF) 1524 and a Compute Service Function (Comp SF) 1536. The Comp CF 1524 and the Comp SF 1536 may be parts or functions of the Computing Service Plane. Comp CF 1524 may be a control plane function that provides functionalities such as management of the Comp SF 1536, computing task context generation and management (e.g., create, read, modify, delete), interaction with the underlaying computing infrastructure for computing resource management, etc. Comp SF 1536 may be a user plane function that serves as the gateway to interface computing service users (such as UE 1502) and computing nodes behind a Comp SF instance. Some functionalities of the Comp SF 1536 may include: parse computing service data received from users to compute tasks executable by computing nodes; hold service mesh ingress gateway or service API gateway; service and charging policies enforcement; performance monitoring and telemetry collection, etc. In some examples, a Comp SF 1536 instance may serve as the user plane gateway for a cluster of computing nodes. A Comp CF 1524 instance may control one or more Comp SF 1536 instances.

Two other such functions may include a Communication Control Function (Comm CF) 1528 and a Communication Service Function (Comm SF) 1538, which may be parts of the Communication Service Plane. The Comm CF 1528 may be the control plane function for managing the Comm SF 1538, communication sessions creation/configuration/releasing, and managing communication session context. The Comm SF 1538 may be a user plane function for data transport. Comm CF 1528 and Comm SF 1538 may be considered as upgrades of SMF 1246 and UPF 1248, which were described with respect to a 5G system in FIG. 12. The upgrades provided by the Comm CF 1528 and the Comm SF 1538 may enable service-aware transport. For legacy (e.g., 4G or 5G) data transport, SMF 1246 and UPF 1248 may still be used.

Two other such functions may include a Data Control Function (Data CF) 1522 and Data Service Function (Data SF) 1532 may be parts of the Data Service Plane. Data CF 1522 may be a control plane function and provides functionalities such as Data SF 1532 management, Data service creation/configuration/releasing, Data service context management, etc. Data SF 1532 may be a user plane function and serve as the gateway between data service users (such as UE 1502 and the various functions of the 6G CN 1510) and data service endpoints behind the gateway. Specific functionalities may include: parse data service user data and forward to corresponding data service endpoints, generate charging data, report data service status.

Another such function may be the Service Orchestration and Chaining Function (SOCF) 1520, which may discover, orchestrate and chain up communication/computing/data services provided by functions in the network. Upon receiving service requests from users, SOCF 1520 may interact with one or more of Comp CF 1524, Comm CF 1528, and Data CF 1522 to identify Comp SF 1536, Comm SF 1538, and Data SF 1532 instances, configure service resources, and generate the service chain, which could contain multiple Comp SF 1536, Comm SF 1538, and Data SF 1532 instances and their associated computing endpoints. Workload processing and data movement may then be conducted within the generated service chain. The SOCF 1520 may also responsible for maintaining, updating, and releasing a created service chain.

Another such function may be the service registration function (SRF) 1514, which may act as a registry for system services provided in the user plane such as services provided by service endpoints behind Comp SF 1536 and Data SF 1532 gateways and services provided by the UE 1502. The SRF 1514 may be considered a counterpart of NRF 1254, which may act as the registry for network functions.

Other such functions may include an evolved service communication proxy (eSCP) and service infrastructure control function (SICF) 1526, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 712 and eSCP-U 1534, for control plane service communication proxy and user plane service communication proxy, respectively. The SICF 1526 may control and configure eCSP instances in terms of service traffic routing policies, access rules, load balancing configurations, performance monitoring, etc.

Another such function is the AMF 1544. The AMF 1544 may be similar to 1244, but with additional functionality. Specifically, the AMF 1544 may include potential functional repartition, such as move the message forwarding functionality from the AMF 1544 to the RAN 1508.

Another such function is the service orchestration exposure function (SOEF) 1518. The SOEF may be configured to expose service orchestration and chaining services to external users such as applications.

The UE 1502 may include an additional function that is referred to as a computing client service function (comp CSF) 1504. The comp CSF 1504 may have both the control plane functionalities and user plane functionalities, and may interact with corresponding network side functions such as SOCF 1520, Comp CF 1524, Comp SF 1536, Data CF 1522, and/or Data SF 1532 for service discovery, request/response, compute task workload exchange, etc. The Comp CSF 1504 may also work with network side functions to decide on whether a computing task should be run on the UE 1502, the RAN 1508, and/or an element of the 6G CN 1510.

The UE 1502 and/or the Comp CSF 1504 may include a service mesh proxy 1506. The service mesh proxy 1506 may act as a proxy for service-to-service communication in the user plane. Capabilities of the service mesh proxy 1506 may include one or more of addressing, security, load balancing, and/or the like.

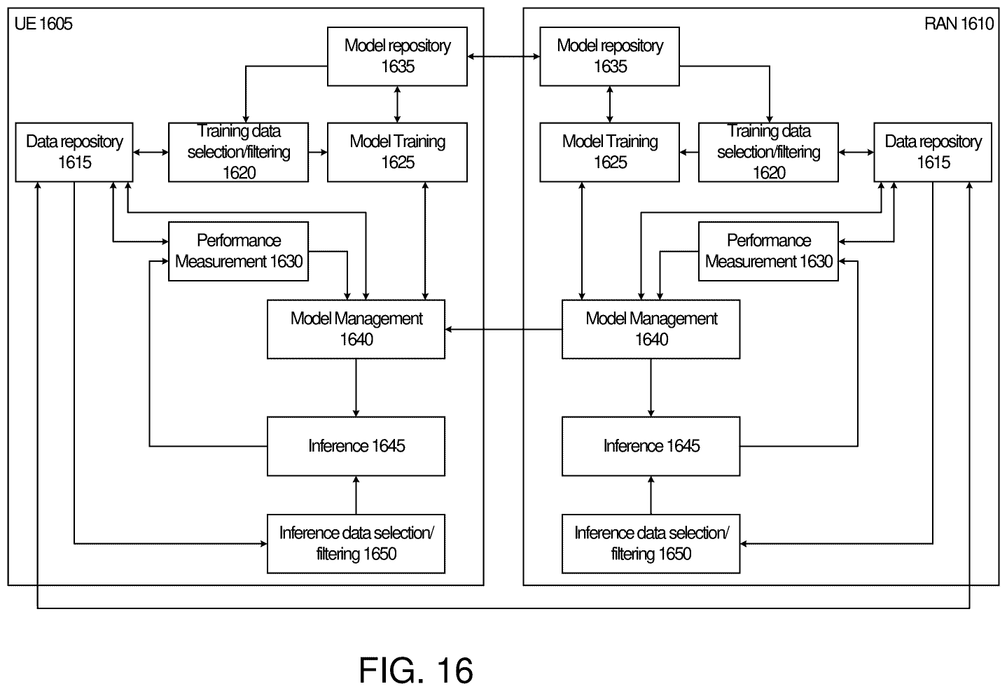

FIG. 16 illustrates a simplified block diagram of artificial (AI)-assisted communication between a user equipment and a radio access network, in accordance with one or more example embodiments of the present disclosure.

FIG. 16 depicts an example artificial (AI)-assisted communication architecture. More specifically, as described in further detail below, AI/machine learning (ML) models may be used or leveraged to facilitate over-the-air communication between UE 1605 and RAN 1610.

In this example, the UE 1605 and the RAN 1610 operate in a matter consistent with 3GPP technical specifications and/or technical reports for 6G systems. In some examples, the wireless cellular communication between the UE 1605 and the RAN 1610 may be part of, or operate concurrently with, networks 1200, 1500, and/or some other network described herein.

The UE 1605 may be similar to, and share one or more features with, UE 1202, UE 1502, and/or some other UE described herein. The UE 1605 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc. The RAN 1610 may be similar to, and share one or more features with, RAN 1214, RAN 1508, and/or some other RAN described herein.

As may be seen in FIG. 16, the AI-related elements of UE 1605 may be similar to the AI-related elements of RAN 1610. For the sake of discussion herein, description of the various elements will be provided from the point of view of the UE 1605, however it will be understood that such discussion or description will apply to equally named/numbered elements of RAN 1610, unless explicitly stated otherwise.

As previously noted, the UE 1605 may include various elements or functions that are related to AI/ML. Such elements may be implemented as hardware, software, firmware, and/or some combination thereof. In examples, one or more of the elements may be implemented as part of the same hardware (e.g., chip or multi-processor chip), software (e.g., a computing program), or firmware as another element.

One such element may be a data repository 1615. The data repository 1615 may be responsible for data collection and storage. Specifically, the data repository 1615 may collect and store RAN configuration parameters, measurement data, performance key performance indicators (KPIs), model performance metrics, etc., for model training, update, and inference. More generally, collected data is stored into the repository. Stored data can be discovered and extracted by other elements from the data repository 1615. For example, as may be seen, the inference data selection/filter element 1650 may retrieve data from the data repository 815. In various examples, the UE 1605 may be configured to discover and request data from the data repository 1615 in the RAN, and vice versa. More generally, the data repository 1615 of the UE 1605 may be communicatively coupled with the data repository 1615 of the RAN 1610 such that the respective data repositories of the UE and the RAN may share collected data with one another.

Another such element may be a training data selection/filtering functional block 1620. The training data selection/filter functional block 1620 may be configured to generate training, validation, and testing datasets for model training. Training data may be extracted from the data repository 1615. Data may be selected/filtered based on the specific AI/ML model to be trained. Data may optionally be transformed/augmented/pre-processed (e.g., normalized) before being loaded into datasets. The training data selection/filter functional block 1620 may label data in datasets for supervised learning. The produced datasets may then be fed into model training the model training functional block 1625.

As noted above, another such element may be the model training functional block 1625. This functional block may be responsible for training and updating (re-training) AI/ML models. The selected model may be trained using the fed-in datasets (including training, validation, testing) from the training data selection/filtering functional block. The model training functional block 1625 may produce trained and tested AI/ML models which are ready for deployment. The produced trained and tested models can be stored in a model repository 1635.

The model repository 1635 may be responsible for AI/ML models' (both trained and un-trained) storage and exposure. Trained/updated model(s) may be stored into the model repository 1635. Model and model parameters may be discovered and requested by other functional blocks (e.g., the training data selection/filter functional block 1620 and/or the model training functional block 1625). In some examples, the UE 1605 may discover and request AI/ML models from the model repository 1635 of the RAN 1610. Similarly, the RAN 1610 may be able to discover and/or request AI/ML models from the model repository 1635 of the UE 1605. In some examples, the RAN 1610 may configure models and/or model parameters in the model repository 1635 of the UE 1605.

Another such element may be a model management functional block 1640. The model management functional block 1640 may be responsible for management of the AI/ML model produced by the model training functional block 1625. Such management functions may include deployment of a trained model, monitoring model performance, etc. In model deployment, the model management functional block 1640 may allocate and schedule hardware and/or software resources for inference, based on received trained and tested models. As used herein, “inference” refers to the process of using trained AI/ML model(s) to generate data analytics, actions, policies, etc. based on input inference data. In performance monitoring, based on wireless performance KPIs and model performance metrics, the model management functional block 1640 may decide to terminate the running model, start model re-training, select another model, etc. In examples, the model management functional block 1640 of the RAN 1610 may be able to configure model management policies in the UE 1605 as shown.

Another such element may be an inference data selection/filtering functional block 1650. The inference data selection/filter functional block 1650 may be responsible for generating datasets for model inference at the inference functional block 1645, as described below. Specifically, inference data may be extracted from the data repository 1615. The inference data selection/filter functional block 1650 may select and/or filter the data based on the deployed AI/ML model. Data may be transformed/augmented/pre-processed following the same transformation/augmentation/pre-processing as those in training data selection/filtering as described with respect to functional block 1620. The produced inference dataset may be fed into the inference functional block 1645.

Another such element may be the inference functional block 1645. The inference functional block 1645 may be responsible for executing inference as described above. Specifically, the inference functional block 1645 may consume the inference dataset provided by the inference data selection/filtering functional block 1650, and generate one or more outcomes. Such outcomes may be or include data analytics, actions, policies, etc. The outcome(s) may be provided to the performance measurement functional block 1630.

The performance measurement functional block 1630 may be configured to measure model performance metrics (e.g., accuracy, model bias, run-time latency, etc.) of deployed and executing models based on the inference outcome(s) for monitoring purpose. Model performance data may be stored in the data repository 1615.

The following examples pertain to further embodiments.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Various embodiments are described below.

Example 1 may include a wireless communications network service-based architecture for providing data query and manipulation services, the wireless communications network service-based architecture comprising processing circuitry for a network function coupled to storage for storing information associated with the data query and manipulation services, the processing circuitry configured to: detect a request from a service consumer, received at a GraphQL interface of the network function, to query or manipulate data; and provide, using the GraphQL interface, a response to the request.

Example 2 may include the wireless communications network service-based architecture of example 1 and/or any other example herein, wherein the network function is paired with a database that supports GraphQL query language.

Example 3 may include the wireless communications network service-based architecture of example 2 and/or any other example herein, wherein the service consumer supports GraphQL client functionality.

Example 4 may include the wireless communications network service-based architecture of example 1 and/or any other example herein, wherein the data query and manipulation services of the network function support the GraphQL interface.

Example 5 may include the wireless communications network service-based architecture of example 4 and/or any other example herein, wherein other data query and manipulation services of the network function not supporting data query or manipulation use a RESTful interface of the network function.

Example 6 may include the wireless communications network service-based architecture of example 1 and/or any other example herein, wherein a data service function (DSF) of the wireless communications network service-based architecture is configured to provide network mediation functionality for data service access, and comprises GraphQL interfaces and RESTful interfaces.

Example 7 may include the wireless communications network service-based architecture of example 6 and/or any other example herein, wherein the DSF is a single-entry endpoint for accessing all data sources based on consolidating all schemas into a single GraphQL schema.

Example 8 may include the wireless communications network service-based architecture of example 6 and/or any other example herein, wherein the DSF interacts with different application programming interface schema-based data sources comprising the network function, at least one additional network function of the wireless communications network service-based architecture, and at least one external data source, and wherein the response uses a GraphQL format.

Example 9 may include the wireless communications network service-based architecture of any of examples 1-8 and/or any other example herein, wherein a protocol stack is used for the GraphQL interface.

Example 10 may include the wireless communications network service-based architecture of example 1 and/or any other example herein, wherein the GraphQL interface uses JavaScript Object Notation (JSON) as a serialization format.

Example 11 may include the wireless communications network service-based architecture of example 1 and/or any other example herein, wherein the GraphQL interface uses a same HperText Transfer Protocol (HTTP) or transport protocol as a Fifth Generation (5G) communications service-based architecture.

Example 12 may include the wireless communications network service-based architecture of example 1 and/or any other example herein, wherein a default port number for the GraphQL interface is different than a default port number of a RESTful interface of the network function.

Example 13 may include the wireless communications network service-based architecture of example 1 and/or any other example herein, wherein the GraphQL interface uses a same security protocol as a 5G service-based architecture.

Example 14 may include the wireless communications network service-based architecture of example 1 and/or any other example herein, wherein the GraphQL interface uses a same syntax as interface definition language (IDL), and wherein the same syntax as the IDL is different than a syntax used by a RESTful interface of the network function.

Example 15 may include the wireless communications network service-based architecture of example 1 and/or any other example herein, wherein the GraphQL interface uses a uniform resource identifier (URI) with a structure of application programming interface (API) root, API name, and GraphQL.

Example 16 may include the wireless communications network service-based architecture of any of examples 1-15 and/or any other example herein, wherein the request is a HTTP GET request to query the data.

Example 17 may include the wireless communications network service-based architecture of any of examples 1-15 and/or any other example herein, wherein the request is a HTTP POST request to add, update, or delete the data.

Example 18 may include the wireless communications network service-based architecture of any of examples 1-15 and/or any other example herein, wherein a transport protocol used by the GraphQL interface may be a web socket or HTTP.

Example 19 may include the wireless communications network service-based architecture of any of examples 1-15 and/or any other example herein, wherein the processing circuitry is further configured to: obtain, by the network service function, notification endpoint information of the service consumer from a network repository function of the wireless communications network service-based architecture.

Example 20 may include the wireless communications network service-based architecture of any of examples 1-15 and/or any other example herein, wherein the GraphQL interface comprises a data query service operation for fetching the data, a data creation service operation for adding the data, a data update service operation for modifying the data, a data delete service operation for deleting the data, and a subscribe and notify service operation for changes to the data.

Example 21 may include a computer-readable storage medium comprising instructions to cause processing circuitry of a network function of a wireless communications network service-based architecture for providing data query and manipulation services, upon execution of the instructions by the processing circuitry, to: detect a request from a service consumer, received at a GraphQL interface of the network function, to query or manipulate data; and provide, using the GraphQL interface, a response to the request.

Example 22 may include a method for providing data query and manipulation services, the method comprising: detecting, by a network function of a wireless communications network service-based architecture, a request from a service consumer to query or manipulate data, wherein the request is received at a GraphQL interface of the network function; and providing, by the network function, using the GraphQL interface, a response to the request.

Example 23 may include the method of example 22 and/or any other example herein, wherein the network function is paired with a database that supports GraphQL query language.

Example 24 may include an apparatus comprising means for: detecting a request from a service consumer, received at a GraphQL interface of the network function, to query or manipulate data; and providing, using the GraphQL interface, a response to the request.

Example 25 may include one or more non-transitory computer-readable media comprising instructions to cause an electronic device, upon execution of the instructions by one or more processors of the electronic device, to perform one or more elements of a method described in or related to any of examples 1-24, or any other method or process described herein.

Example 26 may include an apparatus comprising logic, modules, and/or circuitry to perform one or more elements of a method described in or related to any of examples 1-24, or any other method or process described herein.

Example 27 may include a method, technique, or process as described in or related to any of examples 1-24, or portions or parts thereof.

Example 28 may include an apparatus comprising: one or more processors and one or more computer readable media comprising instructions that, when executed by the one or more processors, cause the one or more processors to perform the method, techniques, or process as described in or related to any of examples 1-24, or portions thereof.

Example 29 may include a method of communicating in a wireless network as shown and described herein.

Example 30 may include a system for providing wireless communication as shown and described herein.

Example 31 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

Unless used differently herein, terms, definitions, and abbreviations may be consistent with terms, definitions, and abbreviations defined in 3GPP TR 21.905 v16.0.0 (2019-06) and/or any other 3GPP standard. For the purposes of the present document, the following abbreviations (shown in Table 4) may apply to the examples and embodiments discussed herein.

TABLE 4
Abbreviations

| | |
|---|---|
| 3GPP | Third Generation |
| | Partnership Project |
| 4G | Fourth Generation |
| 5G | Fifth Generation |
| 5GC | 5G Core network |
| AC | Application Client |
| ACK | Acknowledgement |
| ACID | Application Client |
| | Identification |
| AF | Application Function |
| AM | Acknowledged Mode |
| AMBR | Aggregate Maximum Bit |
| | Rate |
| AMF | Access and Mobility |
| | Management Function |
| AN | Access Network |
| ANR | Automatic Neighbour |
| | Relation |
| AP | Application Protocol, |
| | Antenna Port, Access Point |
| API | Application Programming |
| | Interface |
| APN | Access Point Name |
| ARP | Allocation and Retention |
| | Priority |
| ARQ | Automatic Repeat Request |
| AS | Access Stratum |
| ASP | Application Service |
| | Provider |
| ASN.1 | Abstract Syntax Notation |
| | One |
| AUSF | Authentication Server |
| | Function |
| AWGN | Additive White Gaussian |
| | Noise |
| BAP | Backhaul Adaptation |
| | Protocol |
| BCH | Broadcast Channel |
| BER | Bit Error Ratio |
| BFD | Beam Failure Detection |
| BLER | Block Error Rate |
| BPSK | Binary Phase Shift Keying |
| BRAS | Broadband Remote Access |
| | Server |
| BSS | Business Support System |
| BS | Base Station |
| BSR | Buffer Status Report |
| BW | Bandwidth |
| BWP | Bandwidth Part |
| C-RNTI | Cell Radio Network |
| | Temporary Identity |
| CA | Carrier Aggregation, |
| | Certification Authority |
| CAPEX | CAPital EXpenditure |
| CBRA | Contention Based Random |
| | Access |
| CC | Component Carrier, |
| | Country Code, |
| | Cryptographic Checksum |
| CCA | Clear Channel Assessment |
| CCE | Control Channel Element |
| CCCH | Common Control Channel |
| CE | Coverage Enhancement |
| CDM | Content Delivery Network |
| CDMA | Code-Division Multiple |
| | Access |
| CFRA | Contention Free Random |
| | Access |
| CG | Cell Group |
| CGF | Charging Gateway Function |
| CHF | Charging Function |
| CI | Cell Identity |
| CID | Cell-ID (e.g., positioning |
| | method) |
| CIM | Common Information |
| | Model |
| CIR | Carrier to Interference |
| | Ratio |
| CK | Cipher Key |
| CM | Connection Management, |
| | Conditional Mandatory |
| CMAS | Commercial Mobile Alert |
| | Service |
| CMD | Command |
| CMS | Cloud Management System |
| CO | Conditional Optional |
| CoMP | Coordinated Multi-Point |
| CORESET | Control Resource Set |
| COTS | Commercial Off-The-Shelf |
| CP | Control Plane, Cyclic |
| | Prefix, Connection Point |
| CPD | Connection Point |
| | Descriptor |
| CPE | Customer Premise |
| | Equipment |
| CPICH | Common Pilot Channel |
| CQI | Channel Quality Indicator |
| CPU | CSI processing unit, Central |
| | Processing Unit |
| C/R | Command/Response field |
| | bit |
| CRAN | Cloud Radio Access |
| | Network, Cloud RAN |
| CRB | Common Resource Block |
| CRC | Cyclic Redundancy Check |
| CRI | Channel-State Information |
| | Resource Indicator, CSI-RS |
| | Resource Indicator |
| C-RNTI | Cell RNTI |
| CS | Circuit Switched |
| CSAR | Cloud Service Archive |
| CSI | Channel-State Information |
| CSI-IM | CSI Interference |
| | Measurement |
| CSI-RS | CSI Reference Signal |
| CSI-RSRP | CSI reference signal |
| | received power |
| CSI-RSRQ | CSI reference signal |
| | received quality |
| CSI-SINR | CSI signal-to-noise and |
| | interference ratio |
| CSMA | Carrier Sense Multiple |
| | Access |
| CSMA/CA | CSMA with collision |
| | avoidance |
| CSS | Common Search Space, |
| | Cell-specific Search Space |
| CTF | Charging Trigger Function |
| CTS | Clear-to-Send |
| CW | Codeword |
| CWS | Contention Window Size |
| D2D | Device-to-Device |
| DC | Dual Connectivity, Direct |
| | Current |
| DCI | Downlink Control |
| | Information |
| DF | Deployment Flavour |
| DL | Downlink |
| DMTF | Distributed Management |
| | Task Force |
| DPDK | Data Plane Development |
| | Kit |
| DM-RS, DMRS | Demodulation |
| | Reference Signal |
| DN | Data network |
| DNN | Data Network Name |
| DNAI | Data Network Access |
| | Identifier |
| DRB | Data Radio Bearer |
| DRS | Discovery Reference Signal |
| DRX | Discontinuous Reception |
| DSL | Domain Specific Language. |
| | Digital Subscriber Line |
| DSLAM | DSL Access Multiplexer |
| DwPTS | Downlink Pilot Time Slot |
| E-LAN | Ethernet Local Area |
| | Network |
| E2E | End-to-End |
| ECCA | extended clear channel |
| | assessment, extended CCA |
| ECCE | Enhanced Control Channel |
| | Element, Enhanced CCE |
| ED | Energy Detection |
| EDGE | Enhanced Datarates for |
| | GSM Evolution (GSM |
| | Evolution) |
| EAS | Edge Application Server |
| EASID | Edge Application Server |
| | Identification |
| ECS | Edge Configuration Server |
| ECSP | Edge Computing Service |
| | Provider |
| EDN | Edge Data Network |
| EEC | Edge Enabler Client |
| EECID | Edge Enabler Client |
| | Identification |
| EES | Edge Enabler Server |
| EESID | Edge Enabler Server |
| | Identification |
| EHE | Edge Hosting Environment |
| EGMF | Exposure Governance |
| | tableManagement Function |
| EGPRS | Enhanced GPRS |
| EIR | Equipment Identity Register |
| eLAA | enhanced Licensed Assisted |
| | Access, enhanced LAA |
| EM | Element Manager |
| eMBB | Enhanced Mobile |
| | Broadband |
| EMS | Element Management |
| | System |
| eNB | evolved NodeB, E-UTRAN |
| | Node B |
| EN-DC | E-UTRA-NR Dual |
| | Connectivity |
| EPC | Evolved Packet Core |
| EPDCCH | enhanced PDCCH, |
| | enhanced Physical |
| | Downlink Control Cannel |
| EPRE | Energy per resource |
| | element |
| EPS | Evolved Packet System |
| EREG | enhanced REG, enhanced |
| | resource element groups |
| ETSI | European |
| | Telecommunications |
| | Standards Institute |
| ETWS | Earthquake and Tsunami |
| | Warning System |
| eUICC | embedded UICC, |
| | embedded Universal |
| | Integrated Circuit Card |
| E-UTRA | Evolved UTRA |
| E-UTRAN | Evolved UTRAN |
| EV2X | Enhanced V2X |
| F1AP | F1 Application Protocol |
| F1-C | F1 Control plane interface |
| F1-U | F1 User plane interface |
| FACCH | Fast Associated Control |
| | CHannel |
| FACCH/F | Fast Associated Control |
| | Channel/Full rate |
| FACCH/H | Fast Associated Control |
| | Channel/Half rate |
| FACH | Forward Access Channel |
| FAUSCH | Fast Uplink Signalling |
| | Channel |
| FB | Functional Block |
| FBI | Feedback Information |
| FCC | Federal Communications |
| | Commission |
| FCCH | Frequency Correction |
| | CHannel |
| FDD | Frequency Division Duplex |
| FDM | Frequency Division |
| | Multiplex |
| FDMA | Frequency Division |
| | Multiple Access |
| FE | Front End |
| FEC | Forward Error Correction |
| FFS | For Further Study |
| FFT | Fast Fourier Transformation |
| feLAA | further enhanced Licensed |
| | Assisted Access, further |
| | enhanced LAA |
| FN | Frame Number |
| FPGA | Field-Programmable Gate |
| | Array |
| FR | Frequency Range |
| FQDN | Fully Qualified Domain |
| | Name |
| G-RNTI | GERAN Radio Network |
| | Temporary Identity |
| GERAN | GSM EDGE RAN, GSM |
| | EDGE Radio Access |
| | Network |
| GGSN | Gateway GPRS Support |
| | Node |
| GLONASS | GLObal'naya |
| | NAvigatsionnaya |
| | Sputnikovaya Sistema |
| | (Engl.: Global Navigation |
| | Satellite System) |
| gNB | Next Generation NodeB |
| gNB-CUgNB- | Next |
| centralized unit, | Generation NodeB |
| | centralized unit |
| gNB-DUgNB- | Next |
| distributed unit, | Generation NodeB |
| | distributed unit |
| GNSS | Global Navigation Satellite |
| | System |
| GPRS | General Packet Radio |
| | Service |
| GPSI | Generic Public Subscription |
| | Identifier |
| GSM | Global System for Mobile |
| | Communications, Groupe |
| | Spécial Mobile |
| GTP | GPRS Tunneling Protocol |
| GTP-U | GPRS Tunnelling Protocol |
| | for User Plane |
| GTS | Go To Sleep Signal (related |
| | to WUS) |
| GUMMEI | Globally Unique MME |
| | Identifier |
| GUTI | Globally Unique |
| | Temporary UE Identity |
| HARQ | Hybrid ARQ, Hybrid |
| | Automatic Repeat Request |
| HANDO | Handover |
| HFN | HyperFrame Number |
| HHO | Hard Handover |
| HLR | Home Location Register |
| HN | Home Network |
| HO | Handover |
| HPLMN | Home Public Land Mobile |
| | Network |
| HSDPA | High Speed Downlink |
| | Packet Access |
| HSN | Hopping Sequence Number |
| HSPA | High Speed Packet Access |
| HSS | Home Subscriber Server |
| HSUPA | High Speed Uplink Packet |
| | Access |
| HTTP | Hyper Text Transfer |
| | Protocol |
| HTTPS | Hyper Text Transfer |
| | Protocol Secure (https is |
| | http/1.1 over SSL, i.e. port |
| | 443) |
| I-Block | Information Block |
| ICCID | Integrated Circuit Card |
| | Identification |
| IAB | Integrated Access and |
| | Backhaul |
| ICIC | Inter-Cell Interference |
| | Coordination |
| ID | Identity, identifier |
| IDFT | Inverse Discrete Fourier |
| | Transform |
| IE | Information element |
| IBE | In-Band Emission |
| IEEE | Institute of Electrical |
| | and Electronics |
| | Engineers |
| IEI | Information Element |
| | Identifier |
| IEIDL | Information Element |
| | Identifier Data Length |
| IETF | Internet Engineering |
| | Task Force |
| IF | Infrastructure |
| IM | Interference |
| | Measurement, |
| | Intermodulation, IP |
| | Multimedia |
| IMC | IMS Credentials |
| IMEI | International Mobile |
| | Equipment Identity |
| IMGI | International mobile |
| | group identity |
| IMPI | IP Multimedia Private |
| | Identity |
| IMPU | IP Multimedia PUblic |
| | identity |
| IMS | IP Multimedia |
| | Subsystem |
| IMSI | International Mobile |
| | Subscriber Identity |
| IoT | Internet of Things |
| IP | Internet Protocol |
| Ipsec | IP Security, Internet |
| | Protocol Security |
| IP-CAN | IP-Connectivity Access |
| | Network |
| IP-M | IP Multicast |
| IPv4 | Internet Protocol |
| | Version 4 |
| IPv6 | Internet Protocol |
| | Version 6 |
| IR | Infrared |
| IS | In Sync |
| IRP | Integration Reference |
| | Point |
| ISDN | Integrated Services |
| | Digital Network |
| ISIM | IM Services Identity |
| | Module |
| ISO | International |
| | Organisation for |
| | Standardisation |
| ISP | Internet Service |
| | Provider |
| IWF | Interworking-Function |
| I-WLAN | Interworking WLAN |
| | Constraint length of the |
| | convolutional code, USIM |
| | Individual key |
| kB | Kilobyte (1000 bytes) |
| kbps | kilo-bits per second |
| Kc | Ciphering key |
| Ki | Individual subscriber |
| | authentication key |
| KPI | Key Performance |
| | Indicator |
| KQI | Key Quality Indicator |
| KSI | Key Set Identifier |
| ksps | kilo-symbols per second |
| KVM | Kernel Virtual Machine |
| L1 | Layer 1 (physical layer) |
| L1-RSRP | Layer 1 reference signal |
| | received power |
| L2 | Layer 2 (data link layer) |
| L3 | Layer 3 (network layer) |
| LAA | Licensed Assisted |
| | Access |
| LAN | Local Area Network |
| LADN | Local Area Data |
| | Network |
| LBT | Listen Before Talk |
| LCM | LifeCycle Management |
| LCR | Low Chip Rate |
| LCS | Location Services |
| LCID | Logical Channel ID |
| LI | Layer Indicator |
| LLC | Logical Link Control, |
| | Low Layer |
| | Compatibility |
| LPLMN | Local PLMN |
| LPP | LTE Positioning |
| | Protocol |
| LSB | Least Significant Bit |
| LTE | Long Term Evolution |
| LWA | LTE-WLAN |
| | aggregation |
| LWIP | LTE/WLAN Radio |
| | Level Integration with |
| | IPsec Tunnel |
| LTE | Long Term Evolution |
| M2M | Machine-to-Machine |
| MAC | Medium Access Control |
| | (protocol layering |
| | context) |
| MAC | Message authentication |
| | code |
| | (security/encryption |
| | context) |
| MAC-A | MAC used for |
| | authentication and key |
| | agreement (TSG T WG3 |
| | context) |
| MAC-I | MAC used for data |
| | integrity of signalling |
| | messages (TSG T WG3 |
| | context) |
| MANO | Management and |
| | Orchestration |
| MBMS | Multimedia Broadcast |
| | and Multicast Service |
| MBSFN | Multimedia Broadcast |
| | multicast service Single |
| | Frequency Network |
| MCC | Mobile Country Code |
| MCG | Master Cell Group |
| MCOT | Maximum Channel |
| | Occupancy Time |
| MCS | Modulation and coding |
| | scheme |
| MDAF | Management Data |
| | Analytics Function |
| MDAS | Management Data |
| | Analytics Service |
| MDT | Minimization of Drive |
| | Tests |
| ME | Mobile Equipment |
| MeNB | master eNB |
| MER | Message Error Ratio |
| MGL | Measurement Gap |
| | Length |
| MGRP | Measurement Gap |
| | Repetition Period |
| MIB | Master Information |
| | Block, Management |
| | Information Base |
| MIMO | Multiple Input Multiple |
| | Output |
| MLC | Mobile Location Centre |
| MM | Mobility Management |
| MME | Mobility Management |
| | Entity |
| MN | Master Node |
| MNO | Mobile Network |
| | Operator |
| MO | Measurement Object, |
| | Mobile Originated |
| MPBCH | MTC Physical |
| | Broadcast CHannel |
| MPDCCH | MTC Physical |
| | Downlink Control |
| | CHannel |
| MPDSCH | MTC Physical |
| | Downlink Shared |
| | CHannel |
| MPRACH | MTC Physical Random |
| | Access CHannel |
| MPUSCH | MTC Physical Uplink |
| | Shared Channel |
| MPLS | MultiProtocol Label |
| | Switching |
| MS | Mobile Station |
| MSB | Most Significant Bit |
| MSC | Mobile Switching |
| | Centre |
| MSI | Minimum System |
| | Information, MCH |
| | Scheduling Information |
| MSID | Mobile Station Identifier |
| MSIN | Mobile Station |
| | Identification Number |
| MSISDN | Mobile Subscriber |
| | ISDN Number |
| MT | Mobile Terminated, |
| | Mobile Termination |
| MTC | Machine-Type |
| | Communications |
| mMTC | massive MTC, massive |
| | Machine-Type |
| | Communications |
| MU-MIMO | Multi User MIMO |
| MWUS | MTC wake-up signal, |
| | MTC WUS |
| NACK | Negative |
| | Acknowledgement |
| NAI | Network Access |
| | Identifier |
| NAS | Non-Access Stratum, |
| | Non-Access Stratum |
| | layer |
| NCT | Network Connectivity |
| | Topology |
| NC-JT | Non-Coherent Joint |
| | Transmission |
| NEC | Network Capability |
| | Exposure |
| NE-DC | NR-E-UTRA Dual |
| | Connectivity |
| NEF | Network Exposure |
| | Function |
| NF | Network Function |
| NFP | Network Forwarding |
| | Path |
| NFPD | Network Forwarding |
| | Path Descriptor |
| NFV | Network Functions |
| | Virtualization |
| NFVI | NFV Infrastructure |
| NFVO | NFV Orchestrator |
| NG | Next Generation, Next |
| | Gen |
| NGEN-DC | NG-RAN E-UTRA- |
| | NR Dual Connectivity |
| NM | Network Manager |
| NMS | Network Management |
| | System |
| N-PoP | Network Point of |
| | Presence |
| NMIB, | Narrowband MIB |
| N-MIB | |
| NPBCH | Narrowband Physical |
| | Broadcast CHannel |
| NPDCCH | Narrowband Physical |
| | Downlink Control |
| | CHannel |
| NPDSCH | Narrowband Physical |
| | Downlink Shared |
| | CHannel |
| NPRACH | Narrowband Physical |
| | Random Access |
| | CHannel |
| NPUSCH | Narrowband Physical |
| | Uplink Shared CHannel |
| NPSS | Narrowband Primary |
| | Synchronization Signal |
| NSSS | Narrowband Secondary |
| | Synchronization Signal |
| NR | New Radio, Neighbour |
| | Relation |
| NRF | NF Repository Function |
| NRS | Narrowband Reference |
| | Signal |
| NS | Network Service |
| NSA | Non-Standalone |
| | operation mode |
| NSD | Network Service |
| | Descriptor |
| NSR | Network Service Record |
| NSSAI | Network Slice Selection |
| | Assistance Information |
| S-NNSAI | Single-NSSAI |
| NSSF | Network Slice Selection |
| | Function |
| NW | Network |
| NWUS | Narrowband wake-up |
| | signal, Narrowband |
| | WUS |
| NZP | Non-Zero Power |
| O&M | Operation and |
| | Maintenance |
| ODU2 | Optical channel Data |
| | Unit-type 2 |
| OFDM | Orthogonal Frequency |
| | Division Multiplexing |
| OFDMA | Orthogonal Frequency |
| | Division Multiple |
| | Access |
| OOB | Out-of-band |
| OOS | Out of Sync |
| OPEX | OPerating EXpense |
| OSI | Other System |
| | Information |
| OSS | Operations Support |
| | System |
| OTA | over-the-air |
| PAPR | Peak-to-Average Power |
| | Ratio |
| PAR | Peak to Average Ratio |
| PBCH | Physical Broadcast |
| | Channel |
| PC | Power Control, Personal |
| | Computer |
| PCC | Primary Component |
| | Carrier, Primary CC |
| PCell | Primary Cell |
| PCI | Physical Cell ID, |
| | Physical Cell Identity |
| PCEF | Policy and Charging |
| | Enforcement Function |
| PCF | Policy Control Function |
| PCRFPolicy | Control and Charging |
| | Rules Function |
| PDCP | Packet Data |
| | Convergence Protocol, |
| | Packet Data |
| | Convergence Protocol |
| | layer |
| PDCCH | Physical Downlink |
| | Control Channel |
| PDCP | Packet Data |
| | Convergence Protocol |
| PDN | Packet Data Network, |
| | Public Data Network |
| PDSCH | Physical Downlink |
| | Shared Channel |
| PDU | Protocol Data Unit |
| PEI | Permanent Equipment |
| | Identifiers |
| PFD | Packet Flow Description |
| P-GW | PDN Gateway |
| PHICH | Physical hybrid-ARQ |
| | indicator channel |
| PHY | Physical layer |
| PLMN | Public Land Mobile |
| | Network |
| PIN | Personal Identification |
| | Number |
| PM | Performance |
| | Measurement |
| PMI | Precoding Matrix |
| | Indicator |
| PNF | Physical Network |
| | Function |
| PNFD | Physical Network |
| | Function Descriptor |
| PNFR | Physical Network |
| | Function Record |
| POC | PTT over Cellular |
| PP, PTP | Point-to-Point |
| PPP | Point-to-Point Protocol |
| PRACH | Physical RACH |
| PRB | Physical resource block |
| PRG | Physical resource block |
| | group |
| ProSe | Proximity Services, |
| | Proximity-Based |
| | Service |
| PRS | Positioning Reference |
| | Signal |
| PRR | Packet Reception Radio |
| PS | Packet Services |
| PSBCH | Physical Sidelink |
| | Broadcast Channel |
| PSDCH | Physical Sidelink |
| | Downlink Channel |
| PSCCH | Physical Sidelink |
| | Control Channel |
| PSSCH | Physical Sidelink |
| | Shared Channel |
| PSCell | Primary SCell |
| PSS | Primary |
| | Synchronization Signal |
| PSTN | Public Switched |
| | Telephone Network |
| PT-RS | Phase-tracking reference |
| | signal |
| PTT | Push-to-Talk |
| PUCCH | Physical Uplink Control |
| | Channel |
| PUSCH | Physical Uplink Shared |
| | Channel |
| QAM | Quadrature Amplitude |
| | Modulation |
| QCI | QoS class of identifier |
| QCL | Quasi co-location |
| QFI | QoS Flow ID, QoS Flow |
| | Identifier |
| QoS | Quality of Service |
| QPSK | Quadrature (Quaternary) |
| | Phase Shift Keying |
| QZSS | Quasi-Zenith Satellite |
| | System |
| RA-RNTI | Random Access RNTI |
| RAB | Radio Access Bearer, |
| | Random Access Burst |
| RACH | Random Access Channel |
| RADIUS | Remote Authentication |
| | Dial In User Service |
| RAN | Radio Access Network |
| RAND | RANDom number (used |
| | for authentication) |
| RAR | Random Access Response |
| RAT | Radio Access |
| | Technology |
| RAU | Routing Area Update |
| RB | Resource block, Radio |
| | Bearer |
| RBG | Resource block group |
| REG | Resource Element |
| | Group |
| Rel | Release |
| REQ | REQuest |
| RF | Radio Frequency |
| RI | Rank Indicator |
| RIV | Resource indicator value |
| RL | Radio Link |
| RLC | Radio Link Control, |
| | Radio Link Control |
| | layer |
| RLC AM | RLC Acknowledged |
| | Mode |
| RLC UM | RLC Unacknowledged |
| | Mode |
| RLF | Radio Link Failure |
| RLM | Radio Link Monitoring |
| RLM-RS | Reference Signal for |
| | RLM |
| RM | Registration |
| | Management |
| RMC | Reference Measurement |
| | Channel |
| RMSI | Remaining MSI, |
| | Remaining Minimum |
| | System Information |
| RN | Relay Node |
| RNC | Radio Network |
| | Controller |
| RNL | Radio Network Layer |
| RNTI | Radio Network |
| | Temporary Identifier |
| ROHC | RObust Header |
| | Compression |
| RRC | Radio Resource Control, |
| | Radio Resource Control |
| | layer |
| RRM | Radio Resource |
| | Management |
| RS | Reference Signal |
| RSRP | Reference Signal |
| | Received Power |
| RSRQ | Reference Signal |
| | Received Quality |
| RSSI | Received Signal |
| | Strength Indicator |
| RSU | Road Side Unit |
| RSTD | Reference Signal Time |
| | difference |
| RTP | Real Time Protocol |
| RTS | Ready-To-Semd |
| RTT | Round Trip Time |
| Rx | Reception, Receiving, |
| | Receiver |
| S1AP | S1 Application Protocol |
| S1-MMES1 | for the control plane |
| S1-U | S1 for the user plane |
| S-GW | Serving Gateway |
| S-RNTI | SRNC Radio Network |
| | Temporary Identity |
| S-TMSI | SAE Temporary Mobile |
| | Station Identifier |
| SA | Standalone operation |
| | mode |
| SAE | System Architecture |
| | Evolution |
| SAP | Service Access Point |
| SAPD | Service Access Point |
| | Descriptor |
| SAPI | Service Access Point |
| | Identifier |
| SCC | Secondary Component |
| | Carrier, Secondary CC |
| SCell | Secondary Cell |
| SCEF | Service Capability |
| | Exposure Function |
| SC-FDMA | Single Carrier |
| | Frequency Division |
| | Multiple Access |
| SCG | Secondary Cell Group |
| SCM | Security Context |
| | Management |
| SCS | Subcarrier Spacing |
| SCTP | Stream Control |
| | Transmission Protocol |
| SDAP | Service Data Adaptation |
| | Protocol, Service Data |
| | Adaptation Protocol |
| | layer |
| SDL | Supplementary |
| | Downlink |
| SDNF | Structured Data Storage |
| | Network Function |
| SDP | Session Description |
| | Protocol |
| SDSF | Structured Data Storage |
| | Function |
| SDU | Service Data Unit |
| SEAF | Security Anchor |
| | Function |
| SeNB | secondary eNB |
| SEPP | Security Edge Protection |
| | Proxy |
| SFI | Slot format indication |
| SFTD | Space-Frequency Time |
| | Diversity, SFN and |
| | frame timing difference |
| SFN | System Frame Number |
| SgNB | Secondary gNB |
| SGSN | Serving GPRS Support |
| | Node |
| S-GW | Serving Gateway |
| SI | System Information |
| SI-RNTI | System Information |
| | RNTI |
| SIB | System Information |
| | Block |
| SIM | Subscriber Identity |
| | Module |
| SIP | Session Initiated |
| | Protocol |
| SiP | System in Package |
| SL | Sidelink |
| SLA | Service Level |
| | Agreement |
| SM | Session Management |
| SMF | Session Management |
| | Function |
| SMS | Short Message Service |
| SMSF | SMS Function |
| SMTC | SSB-based |
| | Measurement Timing |
| | Configuration |
| SN | Secondary Node, |
| | Sequence Number |
| SoC | System on Chip |
| SON | Self-Organizing |
| | Network |
| SpCell | Special Cell |
| SP-CSI-RNTI | Semi-Persistent CSI |
| | RNTI |
| SPS | Semi-Persistent |
| | Scheduling |
| SQN | Sequence number |
| SR | Scheduling Request |
| SRB | Signalling Radio Bearer |
| SRS | Sounding Reference |
| | Signal |
| SS | Synchronization Signal |
| SSB | Synchronization Signal |
| | Block |
| SSID | Service Set Identifier |
| SS/PBCH | Block |
| SSBRI | SS/PBCH Block |
| | Resource Indicator, |
| | Synchronization Signal |
| | Block Resource |
| | Indicator |
| SSC | Session and Service |
| | Continuity |
| SS-RSRP | Synchronization Signal |
| | based Reference Signal |
| | Received Power |
| SS-RSRQ | Synchronization Signal |
| | based Reference Signal |
| | Received Quality |
| SS-SINR | Synchronization Signal |
| | based Signal to Noise |
| | and Interference Ratio |
| SSS | Secondary |
| | Synchronization Signal |
| SSSG | Search Space Set Group |
| SSSIF | Search Space Set |
| | Indicator |
| SST | Slice/Service Types |
| SU-MIMO | Single User MIMO |
| SUL | Supplementary Uplink |
| TA | Timing Advance, |
| | Tracking Area |
| TAC | Tracking Area Code |
| TAG | Timing Advance Group |
| TAI | Tracking Area Identity |
| TAU | Tracking Area Update |
| TB | Transport Block |
| TBS | Transport Block Size |
| TBD | To Be Defined |
| TCI | Transmission |
| | Configuration Indicator |
| TCP | Transmission |
| | Communication |
| | Protocol |
| TDD | Time Division Duplex |
| TDM | Time Division |
| | Multiplexing |
| TDMA | Time Division Multiple |
| | Access |
| TE | Terminal Equipment |
| TEID | Tunnel End Point |
| | Identifier |
| TFT | Traffic Flow Template |
| TMSI | Temporary Mobile |
| | Subscriber Identity |
| TNL | Transport Network |
| | Layer |
| TPC | Transmit Power Control |
| TPMI | Transmitted Precoding |
| | Matrix Indicator |
| TR | Technical Report |
| TRP, TRxP | Transmission |
| | Reception Point |
| TRS | Tracking Reference |
| | Signal |
| TRx | Transceiver |
| TS | Technical |
| | Specifications, |
| | Technical Standard |
| TTI | Transmission Time |
| | Interval |
| Tx | Transmission, |
| | Transmitting, |
| | Transmitter |
| U-RNTI | UTRAN Radio Network |
| | Temporary Identity |
| UART | Universal Asynchronous |
| | Receiver and |
| | Transmitter |
| UCI | Uplink Control |
| | Information |
| UE | User Equipment |
| UDM | Unified Data |
| | Management |
| UDP | User Datagram Protocol |
| UDSF | Unstructured Data |
| | Storage Network |
| | Function |
| UICC | Universal Integrated |
| | Circuit Card |
| UL | Uplink |
| UM | Unacknowledged Mode |
| UML | Unified Modelling |
| | Language |
| UMTS | Universal Mobile |
| | Telecommunications |
| | System |
| UP | User Plane |
| UPF | User Plane Function |
| URI | Uniform Resource |
| | Identifier |
| URL | Uniform Resource |
| | Locator |
| URLLC | Ultra-Reliable and Low |
| | Latency |
| USB | Universal Serial Bus |
| USIM | Universal Subscriber |
| | Identity Module |
| USS | UE-specific search space |
| UTRA | UMTS Terrestrial Radio |
| | Access |
| UTRAN | Universal Terrestrial |
| | Radio Access Network |
| UwPTS | Uplink Pilot Time Slot |
| V2I | Vehicle-to-Infrastruction |
| V2P | Vehicle-to-Pedestrian |
| V2V | Vehicle-to-Vehicle |
| V2X | Vehicle-to-everything |
| VIM | Virtualized |
| | Infrastructure Manager |
| VL | Virtual Link, |
| VLAN | Virtual LAN, Virtual |
| | Local Area Network |
| VM | Virtual Machine |
| VNF | Virtualized Network |
| | Function |
| VNFFG | VNF Forwarding Graph |
| VNFFGD | VNF Forwarding Graph |
| | Descriptor |
| VNFM | VNF Manager |
| VoIP | Voice-over-IP, Voice- |
| | over-Internet Protocol |
| VPLMN | Visited Public Land |
| | Mobile Network |
| VPN | Virtual Private Network |
| VRB | Virtual Resource Block |
| WiMAX | Worldwide |
| | Interoperability for |
| | Microwave Access |
| WLAN | Wireless Local Area |
| | Network |
| WMAN | Wireless Metropolitan |
| | Area Network |
| WPAN | Wireless Personal Area |
| | Network |
| X2-C | X2-Control plane |
| X2-U | X2-User plane |
| XML | eXtensible Markup |
| | Language |
| XRES | EXpected user |
| | RESponse |
| XOR | eXclusive OR |
| ZC | Zadoff-Chu |
| ZP | Zero Po |

What is claimed is:

1. A wireless communications network service-based architecture for providing data query and manipulation services, the wireless communications network service-based architecture comprising processing circuitry for a network function coupled to storage for storing information associated with the data query and manipulation services, the processing circuitry configured to:
detect a request from a service consumer, received at a GraphQL interface of the network function, to query or manipulate data; and
provide, using the GraphQL interface, a response to the request.

2. The wireless communications network service-based architecture of claim 1, wherein the network function is paired with a database that supports GraphQL query language.

3. The wireless communications network service-based architecture of claim 2, wherein the service consumer supports GraphQL client functionality.

4. The wireless communications network service-based architecture of claim 1, wherein the data query and manipulation services of the network function support the GraphQL interface.

5. The wireless communications network service-based architecture of claim 4, wherein other data query and manipulation services of the network function not supporting data query or manipulation use a RESTful interface of the network function.

6. The wireless communications network service-based architecture of claim 1, wherein a data service function (DSF) of the wireless communications network service-based architecture is configured to provide network mediation functionality for data service access, and comprises GraphQL interfaces and RESTful interfaces.

7. The wireless communications network service-based architecture of claim 6, wherein the DSF is a single-entry endpoint for accessing all data sources based on consolidating all schemas into a single GraphQL schema.

8. The wireless communications network service-based architecture of claim 6, wherein the DSF interacts with different application programming interface schema-based data sources comprising the network function, at least one additional network function of the wireless communications network service-based architecture, and at least one external data source, and wherein the response uses a GraphQL format.

9. The wireless communications network service-based architecture of claim 1, wherein a protocol stack is used for the GraphQL interface.

10. The wireless communications network service-based architecture of claim 1, wherein the GraphQL interface uses JavaScript Object Notation (JSON) as a serialization format.

11. The wireless communications network service-based architecture of claim 1, wherein the GraphQL interface uses a same HperText Transfer Protocol (HTTP) or transport protocol as a Fifth Generation (5G) communications service-based architecture.

12. The wireless communications network service-based architecture of claim 1, wherein a default port number for the GraphQL interface is different than a default port number of a RESTful interface of the network function.

13. The wireless communications network service-based architecture of claim 1, wherein the GraphQL interface uses a same security protocol as a 5G service-based architecture.

14. The wireless communications network service-based architecture of claim 1, wherein the GraphQL interface uses a same syntax as interface definition language (IDL), and wherein the same syntax as the IDL is different than a syntax used by a RESTful interface of the network function.

15. The wireless communications network service-based architecture of claim 1, wherein the GraphQL interface uses a uniform resource identifier (URI) with a structure of application programming interface (API) root, API name, and GraphQL.

16. A computer-readable storage medium comprising instructions to cause processing circuitry of a network function of a wireless communications network service-based architecture for providing data query and manipulation services, upon execution of the instructions by the processing circuitry, to:
detect a request from a service consumer, received at a GraphQL interface of the network function, to query or manipulate data; and
provide, using the GraphQL interface, a response to the request.

17. A method for providing data query and manipulation services, the method comprising:
detecting, by a network function of a wireless communications network service-based architecture, a request from a service consumer to query or manipulate data, wherein the request is received at a GraphQL interface of the network function; and
providing, by the network function, using the GraphQL interface, a response to the request.

18. The method of claim 17, wherein the network function is paired with a database that supports GraphQL query language.

19. The method of claim 17, wherein the network function is paired with a database that supports GraphQL query language.

20. The method of claim 17, wherein the data query and manipulation services of the network function support the GraphQL interface.
